(19) United States
(12) Patent Application Publication
(10) Pub. No.: US 2002/0154387 A1
(43) Pub. Date: Oct. 24, 2002

(54) Gain equalizer, collimator with gain equalizer and method of manufacturing gain equalizer

(76) Inventors: Kenji Mori, Osaka-shi (JP); Toshiaki Anzaki, Osaka-shi (JP); Takayuki Toyoshima, Osaka-shi (JP); Daisuke Arai, Osaka-shi (JP)

Correspondence Address: Y. ROCKY TSAO, Fish & Richardson P.C., 225 Franklin Street, Boston, MA, 02110-2804, US

(21) Appl. No.: 10/125,678

(22) Filed: Apr. 18, 2002

(30) Foreign Application Priority Data
Apr. 20, 2001 (JP) 2001-123467
Jan. 28, 2002 (JP) 2002-018713

(51) Int. Cl. H01S 3/00

(52) U.S. Cl. 359/337.1

(57) ABSTRACT

Disclosed is a gain equalizer which can adequately flatten the gain spectrum of an optical amplifier by reducing a deviation in center wavelength in accordance with a change in temperature, thereby improving the reproducibility and mass-productivity. The gain equalizer includes a minus filter. The minus filter includes a dielectric multilayer filter which has a transparent base having a first surface, a first dielectric thin film formed on the first surface and a second dielectric thin film formed on the first dielectric thin film. A difference between a refractive index of the first dielectric thin film and a refractive index of the second dielectric thin film is relatively small so that the minus filter has a reflection characteristic for reflecting an optical signal of a predetermined wavelength band including the peak wavelength of the gain spectrum.

### BACKGROUND OF THE INVENTION

The present invention relates to a gain equalizer, and, more particularly, to a gain equalizer for compensating for a wavelength dependency of the gain of an optical amplifier, such as an erbium (Er) doped optical fiber amplifier (EDFA) or a semiconductor optical amplifier, a collimator equipped with a gain equalizer and a method of manufacturing a gain equalizer.

A WDM (Wavelength Division Multiplexing) transmission system is one technique to realize large-capacity optical communication systems. The WDM transmission system transfers a multiplexed optical signal having a plurality of optical signals with different wavelengths multiplexed by a single optical fiber. An optical fiber amplifier which has a rare-earth doped optical fiber as an amplifier medium can amplify lights of different wavelengths at a time. Realizing a long-distance, large-capacity optical communication system by the WDM transmission system requires an optical amplifier such as an optical fiber amplifier which amplifies a multiplexed optical signal.

A number of Er doped optical fiber amplifiers (EDFAs) have been developed as optical fiber amplifiers and put to practical use so far because of the wide gain band. As the emission intensity provided by the stimulated emission of Er ions varies depending on the wavelength, the gain of an EDFA has a wavelength dependency. Therefore, the intensity of a multiplexed optical signal output from the EDFA varies from one wavelength to another.

In a case where an EDFA is used in the WDM transmission system, particularly in case of cascade-connecting multiple EDFAs, the wavelength dependency of the gain is accumulated. At the time a multiplexed optical signal is demultiplexed wavelength by wavelength by a demultiplexer and optical signals of individual wavelengths are received by different receivers on the receiver side, if the intensity of an optical signal differs from one wavelength to another, there arise problems, such as the degradation of crosstalk among the wavelengths and a difficulty in setting the light reception levels of the individual receivers.

In the WDM transmission system that has multiple EDFAs connected, therefore, the wavelength dependency of the gain of each EDFA is compensated for by a gain equalizer.

Known gain equalizers are the fiber Bragg grating (FBG) type, etalon type, Mach-Zehnder type, optical fiber coupler type and dielectric multilayer type. Of those systems, the FBG system and etalon system are partly have been put to practical use or are expected to be industrially utilized.

The gain spectrum of an EDFA has a double peak property as shown in FIG. 1A. Accordingly, the gain equalizer compensates for the wavelength dependency of the gain by placing a loss spectrum over the gain spectrum of the EDFA. The loss spectrum is separated into a plurality of peaks. A plurality of optical filters (minus filters) #1 to #3 which have reflection characteristics corresponding to wavelength bands respectively including the separated peaks (hereinafter called “reflection bands”) are connected to a WDM transmission system as shown in FIG. 1B. Accordingly, the combined loss spectrum (see the solid line in FIG. 1C) which the loss spectra of the minus filters #1 to #3 combined is placed over the gain spectrum shown in FIG. 1A. As a result, the gain spectrum of the EDFA is flattened, as shown in FIG. 1D.

As shown in FIG. 2, the minus filters are required of the following characteristics.

(1) They should have a narrow reflection band. For example, the reflection band should be equal to or narrower than 100 nm.

(2) They should have a desired transmittance (e.g., a transmittance of about 50 to 80%) in the reflection band.

(3) There should be few ripples in the transmission band (the wavelength band other than the reflection band) and the transmittance of the transmission band should be close to 100%.

The characteristics (1) and (2) are needed to adequately flatten the gain spectrum of the EDFA. The characteristic (3) is needed to prevent the intensity of a multiplexed optical signal from being degraded in the wavelength band where placing the loss spectrum over the gain spectrum is unnecessary. The demanded conditions should be considered particularly in a case where multiple EDFAs are connected to a gain equalizer.

FBG type gain equalizers are disclosed in, for example, OPTRONICS (1998) No. 5, p 138-143 and Japanese Unexamined Patent Publication No. Hei 11-119030. Etalon type gain equalizers are disclosed in, for example, Japanese Unexamined Patent Publication No. 2000-82858, Japanese Unexamined Patent Publication No. Hei 9-259349 and Japanese Unexamined Patent Publication No. Hei 9-18416.

However, the optical characteristics of conventional FBG type gain equalizers have temperature dependency. The refractive index of germanium (Ge) doped quartz that constitutes the core and the length of the fiber depend on the temperature. Therefore, the FBG type gain equalizers suffer a non-negligible deviation of the center wavelength in accordance with a change in temperature. The deviation of the center wavelength should be compensated for somehow.

In a case where a relatively thick etalon plate of several mm in thickness is used in the etalon type gain equalizer, the optical characteristic of the etalon type gain equalizer has temperature dependency because the volume of the etalon plate changes with a change in temperature. In the etalon type gain equalizer, therefore, the center wavelength may also have a non-negligible deviation in accordance with a change in temperature. To cancel out the temperature dependency of the gain equalizer, the prior art technique-disclosed in Japanese Unexamined Patent Publication No. 2000-82858 uses a fiber grating or a dielectric multilayer filter in order to compensate for a ripple component which is a difference between the loss wavelength characteristic to flatten the gain and the loss wavelength characteristic provided by the etalon filter.

The etalon type gain equalizer must meet requirements that the size of a cavity later between opposing translucent films should be set to an integer multiple of λ/2 in such a way that the minus filters have a narrow reflection band and that the planarization and flatness of the opposing transparent films should be set very accurately. This makes it difficult to manufacture the minus filters.

### SUMMARY OF THE INVENTION

Accordingly, it is one objective of the present invention to provide a gain equalizer which can adequately flatten the gain spectrum of an optical amplifier by reducing a deviation in center wavelength in accordance with a change in temperature, thereby improving the reproducibility and mass-productivity.

It is another objective of the invention to provide a gain equalizer which can ensure a large difference between different refractive indexes of two kinds of dielectric thin films laminated alternately and ensure a reduction in the number of layers of both dielectric thin films.

It is a further objective of the invention to provide a collimator equipped with a gain equalizer, which is easily assembled into a WDM transmission apparatus and can adequately flatten the gain spectrum of an optical amplifier.

It is a still further objective of the invention to provide a gain equalizer manufacturing method which can easily form a dielectric multilayer filter and can easily manufacture a gain equalizer excellent in temperature characteristic, reproducibility and mass-productivity.

To achieve the above object, the present invention provides a gain equalizer for flattening a gain spectrum of an optical amplifier for amplifying a multiplexed optical signal having optical signals with a plurality of different wavelengths multiplexed. The gain spectrum has a gain peak and the gain peak has a peak wavelength. The gain equalizer includes a minus filter. The minus filter includes a transparent base having a first surface and a dielectric multilayer filter. The dielectric multilayer filter has a first dielectric thin film formed on the first surface and a second dielectric thin film formed on the first dielectric thin film. Both the first dielectric thin film and the second dielectric thin film have refractive indexes. The difference between the refractive index of the first dielectric thin film and the refractive index of the second dielectric thin film is relatively small so that the minus filter has a reflection characteristic for reflecting an optical signal, of a predetermined wavelength band including the peak wavelength of the gain spectrum.

A further perspective of the present invention is a collimator connected to first and second single-mode optical fibers and having a gain equalizer. The gain equalizer flattens a gain spectrum of an optical amplifier for amplifying a multiplexed optical signal having optical signals with a plurality of different wavelengths multiplexed. The gain spectrum has a gain peak and the gain peak has a peak wavelength. The gain equalizer includes a minus filter. The minus filter includes an incident side collimator lens for converting light output from the first single-mode optical fiber to parallel light and a dielectric multilayer filter formed on a surface of the incident side collimator lens. A reception side collimator lens is adhered to a surface of the dielectric multilayer filter to couple the parallel light to the second single-mode optical fiber. The dielectric multilayer filter includes a first dielectric thin film formed on the surface of the incident side collimator lens and a second dielectric thin film formed on the first dielectric thin film. Both the first dielectric thin film and the second dielectric thin film have refractive indexes. The difference between the refractive index of the first dielectric thin film and the refractive index of the second dielectric thin film is relatively small so that the dielectric multilayer filter has a reflection characteristic for reflecting an optical signal of a predetermined wavelength band including the peak wavelength of the gain spectrum.

A further perspective of the present invention is a method of manufacturing a gain equalizer. The method includes the steps of preparing a transparent base, forming a first dielectric thin film by depositing a first metal material on a surface of the transparent base by physical vapor deposition, forming a second dielectric thin film by depositing a second metal material having a composition slightly different from a composition of the first metal material on a surface of the first dielectric thin film by physical vapor deposition, and forming a dielectric multilayer filter by alternately depositing a plurality of first dielectric thin films and a plurality of second dielectric thin films on the surface of the transparent base.

A further perspective of the present invention is a method of manufacturing a gain equalizer. The method includes the steps of preparing a transparent base, forming a first dielectric thin film by depositing a first metal material on a surface of the transparent base by chemical vapor deposition, forming a second dielectric thin film by depositing a second metal material having a composition slightly different from a composition of the first metal material on a surface of the first dielectric thin film by chemical vapor deposition, and forming a dielectric multilayer filter by alternately depositing a plurality of first dielectric thin films and a plurality of second dielectric thin films on the surface of the transparent base.

A further perspective of the present invention is a method of manufacturing a gain equalizer. The method includes the steps of preparing a transparent base, arranging at least one electrode on the transparent base, forming a first dielectric thin film by supplying power to the at least one electrode to deposit at least one kind of a first metal material on a surface of the transparent base by sputtering, and forming a second dielectric thin film by supplying power to the at least one electrode to deposit at least one kind of a second metal material on a surface of the first dielectric thin film by sputtering. The first and second dielectric thin films have refractive indexes that are different from each other.

A further perspective of the present invention is a gain equalizer for flattening a gain spectrum of an optical amplifier for amplifying a multiplexed optical signal having optical signals with a plurality of different wavelengths multiplexed. The gain spectrum has a gain peak and the gain peak has a peak wavelength λ₀. The gain equalizer includes a minus filter. The minus filter includes a first transparent base and a dielectric multilayer filter. The dielectric multilayer filter has a first dielectric thin film formed on a surface of the first transparent base and a second dielectric thin film formed on the first dielectric thin film. Both the first dielectric thin film and the second dielectric thin film have refractive indexes. The refractive index of the first dielectric thin film is different from the refractive index of the second dielectric thin film. The minus filter reflects an optical signal having the peak wavelength λ₀ of the gain spectrum at a high-order reflection band.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a graph showing the gain spectrum of an EDFA;

FIG. 1B is an explanatory diagram showing an example of the layout of three minus filters;

FIG. 1C is a graph showing the loss spectra and combined loss spectrum of the three minus filters;

FIG. 1D is a graph showing the gain spectrum after gain equalization;

FIG. 2 is a graph for explaining the general characteristics required for minus filters;

FIG. 3 is a schematic partly cross-sectional view of a gain equalizer according to a first embodiment of the invention;

FIG. 4 is a schematic side view of a gain equalizer according to a second embodiment of the invention;

FIG. 5 is a schematic side view of a gain equalizer according to a third embodiment of the invention;

FIG. 6 is a schematic perspective view of a sputtering apparatus which is used in manufacturing the gain equalizers of the invention;

FIG. 7 is a schematic plan view showing the cross section of the sputtering apparatus in FIG. 6;

FIG. 8 is a schematic structural diagram of a collimator equipped with a gain equalizer according to one embodiment of the invention;

FIG. 9 is a schematic structural diagram of a collimator equipped with a gain equalizer according to another embodiment of the invention;

FIG. 10 is a schematic structural diagram of a WDM transmission apparatus according to one embodiment of the invention;

FIG. 11 is a schematic structural diagram of a gain equalization module of the WDM transmission apparatus in FIG. 10;

FIG. 12 is a graph showing the transmission property of a gain equalizer according to Example 1 of the invention;

FIG. 13 is a graph showing the transmission property of a gain equalizer according to Example 2 of the invention;

FIG. 14 is a graph showing the transmission property of a gain equalizer according to Example 3 of the invention;

FIG. 15 is a graph showing the transmission property of a gain equalizer according to Example 4 of the invention;

FIG. 16 is a graph showing the transmission property of a gain equalizer according to Example 5 of the invention;

FIG. 17 is a graph showing the transmission property of a gain equalizer according to Example 6 of the invention;

FIG. 18 is a graph showing the transmission property of a gain equalizer according to Example 7 of the invention;

FIG. 19 is a graph showing the transmission property of a gain equalizer according to Example 8 of the invention;

FIG. 20 is a graph showing the refractive index profile of a gain equalizer according to Example 9 of the invention;

FIG. 21 is a graph showing the transmission property of the gain equalizer according to Example 9 of the invention;

FIG. 22 is a graph showing the transmission property of a gain equalizer according to Comparative Example 1 of the invention;

FIG. 23 is a graph showing the transmission property of a gain equalizer according to Comparative Example 2 of the invention;

FIG. 24 is a graph showing the transmission property of a gain equalizer according to Comparative Example 3 of the invention;

FIG. 25 is a graph showing the transmission property of a gain equalizer according to Comparative Example 4 of the invention;

FIG. 26 is a table illustrating individual pieces of data of Examples 1 to 9 and Comparative Examples 1 to 4;

FIG. 27A is a graph depicting the film structure of a gain equalizer according to a fourth embodiment of the invention;

FIG. 27B is a graph depicting the third-order reflection band of the gain equalizer in FIG. 27A;

FIG. 27C is a partly enlarged view of the gain equalizer in FIG. 27B;

FIG. 28A is a schematic side view of the gain equalizer in FIG. 27A;

FIG. 28B is a partly cross-sectional view of a dielectric multilayer filter in the gain equalizer in FIG. 28A;

FIG. 29 is a schematic structural diagram of a gain equalization module including the gain equalizer in FIG. 28A;

FIG. 30A is a graph depicting the film structure of a gain equalizer according to a fifth embodiment of the invention;

FIG. 30B is a graph depicting the fifth-order reflection band of the gain equalizer in FIG. 30A;

FIG. 31A is a graph depicting the film structure of a gain equalizer according to a sixth embodiment of the invention;

FIG. 31B is a graph depicting the seventh-order reflection band of the gain equalizer in FIG. 31A;

FIG. 32A is a graph depicting the film structure of a gain equalizer according to Comparative Example 5 of the invention; and

FIG. 32B is a graph depicting the first-order reflection band of the gain equalizer in FIG. 32A.

### DETAILED DESCRIPTION OF THE PREFERRED EMBODIMENTS

In the drawings, like numerals are used for like elements throughout.

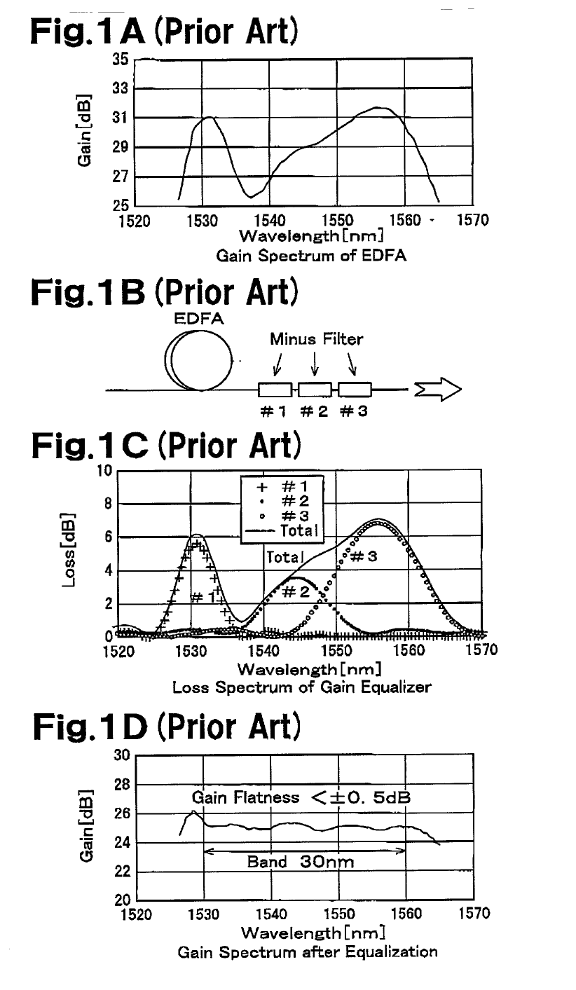

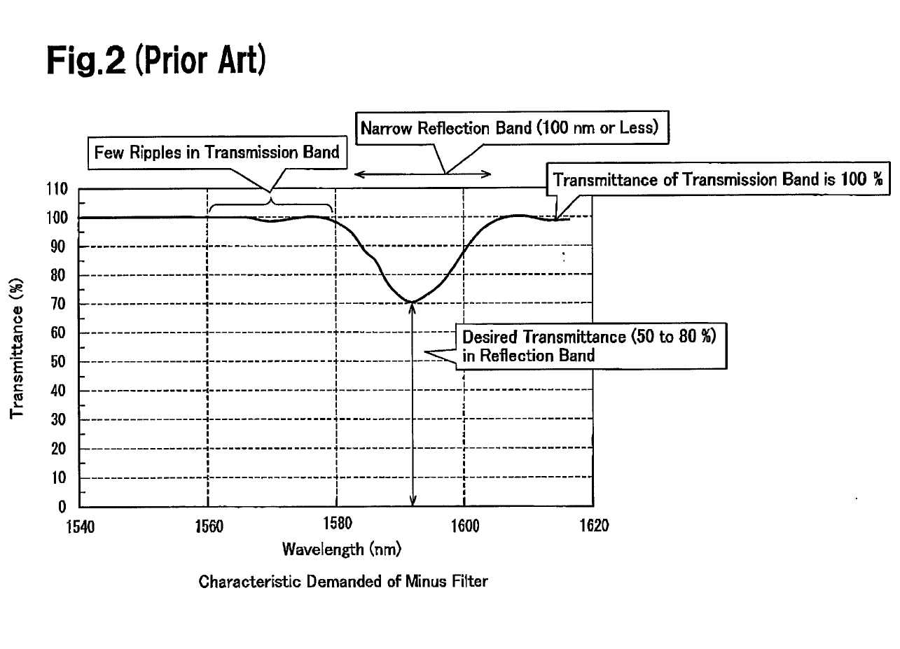

Gain equalizers according to individual embodiments of the invention to be described below flatten the gain spectrum of an optical amplifier which amplifies a multiplexed optical signal including a predetermined optical signals (λ₁ to λₙ) in a WDM transmission type optical communication system. Each gain equalizer is located, for example, before or after an EDFA and provides a loss spectrum corresponding to the gain spectrum (see FIG. 1A) having the wavelength dependency of the EDFA to compensate for the wavelength dependency of the gain of the EDFA. The gain spectrum has a gain peak and the gain peak has a peak wavelength.

In each embodiment, the optical communication system performs optical transmission in a 1550 nm band (1.55 μm band) using a single-mode optical fiber as a transmission path. FIG. 1A shows the gain spectrum of an EDFA in the 1550 nm band. As the refractive index generally has a wavelength dispersion property, the values of the “refractive index” in the following description correspond to lights having a wavelength of 1550 nm unless the wavelength is specified.

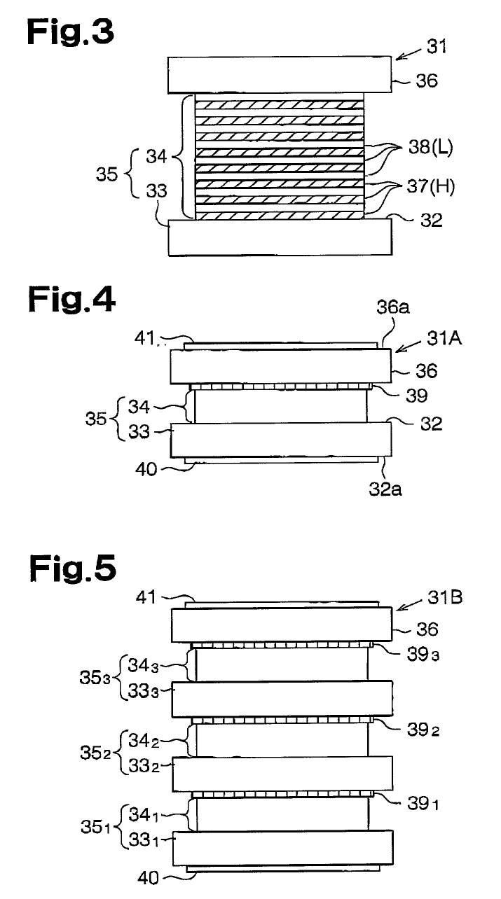

A gain equalizer 31 according to the first embodiment will now be discussed with reference to FIG. 3. The gain equalizer 31 shown in FIG. 3 has a desired reflection characteristic in the reflection band that corresponds to a specific gain peak or a peak wavelength in the gain spectrum of an EDFA. For example, the gain equalizer 31 has a desired reflection characteristic in the reflection band that corresponds to one of two gain peaks included in the gain spectrum of the EDFA shown in FIG. 1A.

The gain equalizer 31 has a single minus filter 35 including a transparent base 33 having a flat surface (first surface) 32 and a dielectric multilayer filter 34 formed on the flat surface 32. The transparent base 33 is a glass substrate. A transparent incidence medium 36 is adhered to the surface of the dielectric multilayer filter 34 opposite to the transparent base 33.

The dielectric multilayer filter 34 have first dielectric thin films 37 with a relatively high refractive index and second dielectric thin films 38 with a slightly lower refractive index than that of the first dielectric thin films 37 alternately laminated by a predetermined layer quantity m in such a way that the minus filter 35 has a desired reflection characteristic in a predetermined reflection band (wavelength band) including the peak wavelength of the gain spectrum.

The structure of the gain equalizer 31 according to the first embodiment is expressed as follows.

“transparent base/(HL)ₘ/incidence medium” where “H” indicates the first dielectric thin film 37 and “L” indicates the second dielectric thin film 38. “HL” indicates a laminated set of the first dielectric thin film 37 and the second dielectric thin film 38. In this case, the first dielectric thin film 37 is formed on the transparent base 33 side. The parameter “m” indicates the number of laminated sets. For example, “(HL)₅” represents the dielectric multilayer filter 34 that has five laminated sets of thin films (HL).

It is preferable that a difference between a refractive index n_{H} of the first dielectric thin film 37 and a refractive index n_{L} of the second dielectric thin film 38 or refractive index difference Δn should lie in a range of 0.003 to 0.04. It is more preferable that the refractive index difference Δn should lie in a range of 0.008 to 0.03. In a case where the refractive index difference Δn is less than 0.003, the refractive index difference is too small so that it makes the advent of the reflection band difficult. In this case, while a significant increase in the number of laminated sets m allows the reflection band to appear, it leads to a cost increase and is not therefore practically desirable.

In a case where the refractive index difference Δn exceeds 0.04, the reflection band becomes wider than 100 nm, thus making it difficult to prepare a gain equalizer which has plural minus filters 35 with different reflection bands. In this case, the transmittances of the reflection bands become lower (the reflectances become greater), so that the intensities of optical signals in the reflection bands would drop.

It is desirable that the refractive index, nₐᵥ, of the dielectric multilayer filter 34 (average refractive index: nₐᵥ=(n_{H}+n_{L})/²) be close to a refractive index nₛ of the transparent base 33. It is preferable that the first refractive index no be equal to or smaller than 1.2 times the refractive index nₛ of the transparent base 33 and the second refractive index n_{L} be equal to or larger than 0.8 times the refractive index nₛ of the transparent base 33. It is more preferable that the first refractive index n_{H} be equal to or smaller than 1.1 times the refractive index nₛ of the transparent base 33 and the second refractive index n_{L} be equal to or larger than 0.9 times the refractive index nₛ of the transparent base 33. Actually, the second dielectric thin film 38 that has the second refractive index n_{L} larger than about 1.3 is selected.

In a case where the difference between the refractive index nₛ of the transparent base 33 and the average refractive index nₐᵥ of the dielectric multilayer filter 34 is large, reflection is likely to occur at the interface between the dielectric multilayer filter 34 and the transparent base 33. A reflection-originated loss generates ripples in the transmission band. The ripples produce a transmission loss of over 1% in the transmission band. The “ripples” mean a rippling spectrum in the transmission band. The ripples decrease the transmittance in the transmission band. In a case where the wavelength in use is in a visible range, the ripples color transmitted light.

[Refractive Index of Incidence Medium]

It is desirable that a refractive index nₘ of the incidence medium 36 should be close to the average refractive index nₐᵥ of the dielectric multilayer filter 34. When the difference between the refractive index nₘ and the refractive index nₐᵥ is large, reflection is likely to occur at the interface between the incidence medium 36 and the filter 34 and a reflection-originated loss appears as ripples in the transmission band. The ripples are not desirable because they produce a transmission loss of over 1% in the transmission band.

As the average refractive index nₐᵥ of the dielectric multilayer filter 34 is set close to the refractive index nₛ of the transparent base 33, the refractive index nₘ of the incidence medium 36 has only to be set equal to the refractive index nₛ of the transparent base 33. It is preferable that the refractive index nₘ of the incidence medium 36 should be 0.8 to 1.2 times the refractive index nₛ of the transparent base 33. It is more preferable that the refractive index nₘ of the incidence medium 36 should be 0.9 to 1.1 times the refractive index nₛ of the transparent base 33. It is desirable that, for example, the incidence medium 36 and the transparent base 33 are made of the same material in order to set the refractive index nₘ of the incidence medium 36 close to the average refractive index nₐᵥ of the dielectric multilayer filter 34.

The gain equalizer 31 according to the first embodiment has the following advantages.

(1) As the minus filter 35 comprises the transparent base 33 and the dielectric multilayer filter 34, the minus filter 35 has a good temperature characteristic. This is because the transparent base 33 and the dielectric multilayer filter 34 are as thin as several tens of micrometers to approximately 100 μm. That is, because the thicknesses of the functional portion (the transparent base 33 and the dielectric multilayer filter 34) that provides the desired optical characteristic (reflection characteristic) is smaller than that of an FBG type or etalon type gain equalizer, the influence of the thermal expansion caused by a change in temperature is small. In addition, the refractive index of the dielectric multilayer filter 34 does not have a temperature dependency. It is therefore possible to reduce the deviation of the center wavelength caused by a change in temperature. This makes it possible to adequately flatten the gain spectrum of an EDFA or the like.

(2) The reflection characteristic is determined only by the refractive indexes and thicknesses of the first and second dielectric thin films 37 and 38 and the number of laminated first and second dielectric thin films 37 and 38. Unlike the etalon type gain equalizer, this gain equalizer does not need to design the planarization and flatness of both translucent films very accurately. This can lead to improvements on the reproducibility and mass-productivity.

(3) The refractive index difference Δn between the refractive indexes of the first and second dielectric thin films 37 and 38 is set to a value lying in a range of 0.003 to 0.04, more preferably, a value lying in a range of 0.008 to 0.03. It is therefore possible to acquire a loss spectrum with a narrow reflection band which corresponds to a specific gain peak in the gain spectrum of the EDFA, for example, one of two gain peaks included in the gain spectrum of the EDFA shown in FIG. 1A. For example, the reflection band can be made equal to or narrower than 100 nm.

(4) As the reflection band can be made equal to or narrower than 100 nm, it is possible to prepare a gain equalizer which has a combination of plural sets of minus filters 35 having different reflection bands.

(5) The refractive index n_{H} is equal to or smaller than 1.2 times the refractive index nₛ of the transparent base 33 and the refractive index n_{L} is equal to or larger than 0.8 times the refractive index nₛ. More preferably, the refractive index n_{H} should be equal to or smaller than 1.1 times the refractive index nₛ and the refractive index n_{L} should be equal to or larger than 0.9 times the refractive index nₛ. Therefore, reflection is not likely to occur at the interface between the dielectric multilayer filter 34 and the transparent base 33. As a result, ripples in the transmission band become smaller, thus making it possible to reduce the transmission loss in the transmission band.

(6) The refractive index nₘ of the incidence medium 36 is 0.8 to 1.2 times the refractive index nₛ of the transparent base 33, more preferably 0.9 to 1.1 times the refractive index nₛ. Therefore, reflection is not likely to occur at the interface between the dielectric multilayer filter 34 and the incidence medium 36. The transmittance in the transmission band becomes higher, thus making it possible to lower the transmission loss in the transmission band. As a result, the gain spectrum of an optical amplifier, such as an EDFA, can be flattened more adequately.

A gain equalizer 31A according to the second embodiment will be discussed below with reference to FIG. 4.

As shown in FIG. 4, the gain equalizer 31A has a single minus filter 35. In the gain equalizer 31A, the incidence medium 36 which is a transparent base is adhered to the surface of the dielectric multilayer filter 34 opposite to the transparent base 33 by an adhesive 39. The adhesive 39 has only to have a refractive index and transmittance which do not degrade the optical performance of the gain equalizer 31A.

The gain equalizer 31A has a structure having the dielectric multilayer filter 34 arranged between the transparent base 33 and the incidence medium 36 or a sandwich structure of the transparent base 33/dielectric multilayer filter 34/transparent base (incidence medium) 36. Antireflection films 40 and 41 are respectively formed on the outer surface (second surface) 32a of the transparent base 33 and the outer surface 36a of the incidence medium 36.

The gain equalizer 31A according to the second embodiment has the following advantages.

(1) The surface of the dielectric multilayer filter 34 which lies opposite to the outer surface of the transparent base 33 and the incidence medium 36 can be adhered together easily by the adhesive 39.

(2) As the antireflection films 40 and 41 are respectively formed on the outer surface of the transparent base 33 and the outer surface of the incidence medium 36, the surface reflectance at each outer surface with respect to light with a wavelength of 1550 nm can be reduced.

A gain equalizer 31B according to the third embodiment will be discussed below with reference to FIG. 5.

As shown in FIG. 5, the gain equalizer 31B includes three minus filters 35₁, 35₂ and 35₃ which have desired reflection characteristics in different wavelength bands respectively corresponding to three gain peaks (two peaks and a small peak therebetween) included in the gain spectrum in FIG. 1A.

The minus filter 35₁ includes a transparent base 33₁ and a dielectric multilayer filter 34₁ and has a desired reflection characteristic in a reflection band corresponding to, for example, a peak wavelength of 1531 nm. The minus filter 35₂ includes a transparent base 33₂ and a dielectric multilayer filter 34₂ and has a desired reflection characteristic in a reflection band corresponding to, for example, a peak wavelength of 1545 nm. The minus filter 35₃ includes a transparent base 33₃ and a dielectric multilayer filter 34₃ and has a desired reflection characteristic in a reflection band corresponding to, for example, a peak wavelength of 1554 nm. Each of the three peak wavelengths corresponds to one of the three gain peaks respectively.

The three minus filters 35₁ to 35₃ are connected to one another in a lamination in the thickness direction. The surface of the dielectric multilayer filter 34₁ is adhered to the flat surface of the transparent base 33₂ by an adhesive 39₁. The surface of the dielectric multilayer filter 34₂ is adhered to the flat surface of the transparent base 33₃ by an adhesive 39₂. The surface of the dielectric multilayer filter 34₃ is adhered to the flat surface of the incidence medium 36 by an adhesive 39₃. The surface of the dielectric multilayer filter 34 may be adhered to the incidence medium 36 without using an adhesive but by, for example, an optical contact scheme.

The gain equalizer 31B according to the third embodiment has the following advantages.

(1) The gain equalizer 31B includes the three minus filters 35₁ to 35₃ which have desired reflection characteristics or different loss spectra (reflection spectra) in different wavelength bands. As the loss spectra of the three minus filters are combined, a loss spectrum which compensates for a gain spectrum as shown in FIG. 1A can be generated. The loss spectrum can flatten the gain spectrum to compensate for the wavelength dependency of the gain of the EDFA. This provides the flattened gain spectrum, e.g., a gain spectrum after equalization as shown in FIG. 1D. As a result, amplified light which does not have a wavelength-dependent intensity deviation can be acquired over a wide wavelength band. This is advantageous in a WDM transmission type optical communication system.

(2) It is possible to cope with gain spectra with various shapes by adequately changing the loss spectra (reflection characteristics) of the three minus filters,

The number of the minus filters 35 may be two or four or greater.

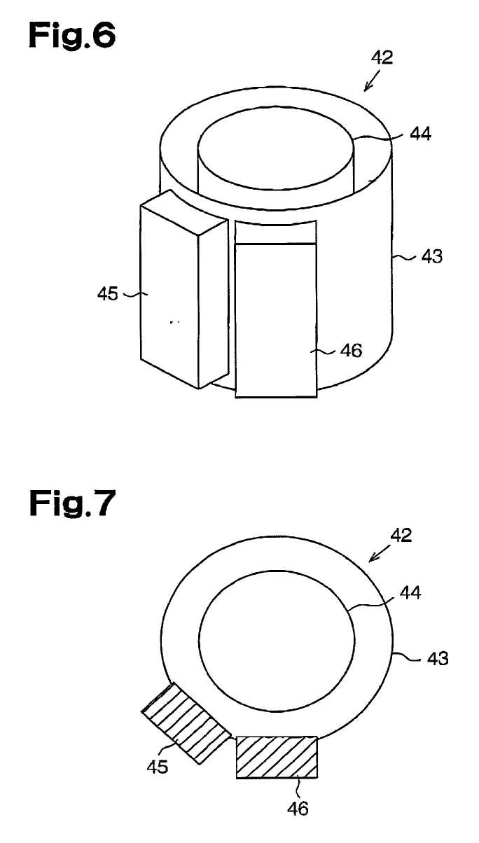

A first method of manufacturing the gain equalizers 31 and 31A will be discussed below with reference to FIGS. 6 and 7.

To manufacture the gain equalizers 31 and 31A according to the first and second embodiments, a sputtering apparatus 42 shown in FIGS. 6 and 7 is used. The sputtering apparatus 42 has a chamber 43, which can be adjusted under an atmosphere depressurized by a vacuum pump (not shown), and a cylindrical holder 44 to which the transparent base 33 is attached. The sputtering apparatus 42 further has a pair of cathodes (electrodes) 45 and 46 attached to the wail of the chamber 43, a pair of targets (not shown) attached to those surfaces of the pair of cathodes 45 and 46 which face the holder (carousel) 44 and reaction gas inlet ports (not shown) provided near the targets. In this embodiment, the pair of cathodes 45 and 46 are provided adjacent to the pair of targets. Sputtering powers to be supplied to the pair of cathodes 45 and 46 are controlled independently.

In the manufacturing method of this embodiment, the first and second dielectric thin films 37 and 38 are alternately laminated on the transparent base 33 intermittently or continuously by sputtering using the sputtering apparatus 42, thereby forming the dielectric multilayer filter 34.

In the manufacturing method, metal targets (first and second metal materials) with slightly different compositions are attached to the cathodes 45 and 46. For example, the material for one of the two metal targets is titanium (Ti) and the other target material is a titanium-niobium alloy (Ti—Nb) containing niobium (Nb) of 10 to 20% by mass. Ti is adhered to the cathode 45, and Ti—Nb to the cathode 46.

At the time of forming the first dielectric thin film 37, sputtering power is supplied to the cathode 45 to which Ti is adhered. At the time of forming the second dielectric thin film 38, sputtering power is supplied to the cathode 46 to which Ti—Nb is adhered.

As the sputtering powers are alternately supplied to the two cathodes 45 and 46, the target materials are deposited as dielectric thin films on the surface of the transparent base 33 attached to the outer side of the holder 44 by reactive sputtering with oxygen as a reaction gas.

Film thickness control on the thin films at the time of alternately laminating the first and second dielectric thin films 37 and 38 should be carried out in such a way that the transmittances of the thin films become designed values while directly measuring the transmittances of the thin films during deposition by using an ordinary direct view type optical monitor.

The first gain equalizer manufacturing method has the following advantages.

By adequately selecting two types of metal materials having slightly different compositions, the first and second dielectric thin films 37 and 38 whose refractive index difference Δn lies within the aforementioned range can be alternately laminated on the transparent base 33 by the desired quantity. Specifically, the refractive index difference Δn between the first and second dielectric thin films 37 and 38 can be easily set within a preferable range of 0.003 to 0.04 by adequately selecting the amount of the niobium (Nb) content in the titanium-niobium alloy (Ti—Nb) within a range of 10 to 20% by mass. This can allow the dielectric multilayer filter 34 of the gain equalizer 31 or 31A shown in FIG. 3 or FIG. 4 to be easily formed on the transparent base 33.

This manufacturing method can also allow the dielectric multilayer filters 34₁ to 34₃ to be easily formed on the respective three transparent bases 33₁ to 33₃ in the gain equalizer 31B shown in FIG. 5.

A second gain equalizer manufacturing method will be discussed below. In the second manufacturing method, the dielectric multilayer filter 34 is formed on the transparent base 33 by sputtering using the sputtering apparatus 42 too.

In the second manufacturing method, the pair of cathodes 45 and 46 are arranged adjacent to each other and different types of metal targets (metal materials) are attached to the cathodes 45 and 46. For example, titanium (Ti) is attached to the cathode 45, and metal silicon (Si) to the cathode 46.

Sputtering powers are supplied to the cathodes 45 and 46 at the same time to sputter the two metal targets simultaneously. As a result, the first and second dielectric thin films 37 and 38, which contain a mixture of titanium oxide (TiOx) of a high refractive index material and silicon oxide (SiOy) of a low refractive index material, on the transparent base 33 by reactive sputtering with oxygen as a reaction gas.

At the time of forming either one of the first and second dielectric thin films 37 and 38, a given sputtering power is supplied to the cathode 45. A sputtering power lower than the sputtering power to the cathode 45 is supplied to the cathode 46. When the first dielectric thin film 37 is formed, the sputtering power to be supplied to the cathode 46 is lower than the one that is supplied when the second dielectric thin film 38 is formed. Therefore, the sputter rate (sputtering ratio) of Si at the time of forming the first dielectric thin film 37 is lower than the sputter rate at the time of forming the second dielectric thin film 38. Consequently, the first and second dielectric thin films 37 and 38 contain the essential material, titanium oxide (TiOx) of a high refractive index material, and silicon oxide (SiOy) of a low refractive index material. The amount of the silicon oxide contained in the first dielectric thin film 37 is smaller than that contained in the second dielectric thin film 38.

The second gain equalizer manufacturing method has the following advantages.

(1) A given sputtering power is always supplied to that of the cathodes 45 and 46 arranged adjacent to each other to which a metal material A that becomes a high refractive index material when being reacted with oxygen. With regard to the cathode to which a metal material B that becomes a low refractive index material when being reacted with oxygen, the sputtering power supplied when the first dielectric thin film 37 is formed differs from the sputtering power supplied when the second dielectric thin film 38 is formed. This permits adequate adjustment of the composition ratio of the dielectric thin films containing a mixture of a high refractive index material and a low refractive index material. As a result, the first and second dielectric thin films 37 and 38 whose refractive index difference Δn lies within a predetermined range are alternately laminated on the transparent base 33 by the desired quantity. Specifically, the composition ratio of the first and second dielectric thin films 37 and 38 containing a mixture of titanium oxide (TiOx) of a high refractive index material and silicon oxide (SiOy) of a low refractive index material is adjusted properly, so that the refractive index difference Δn is easily set within a preferable range of 0.003 to 0.04.

This can allow the dielectric multilayer filter 34 of the gain equalizer 31 or 31A shown in FIG. 3 or FIG. 4 to be easily formed on the transparent base 33. The manufacturing method can also allow the dielectric multilayer filters 34₁ to 34₃ to be easily formed on the respective three transparent bases 33₁ to 33₃ in the gain equalizer 31B shown in FIG. 5.

A third gain equalizer manufacturing method will be discussed below. In the third manufacturing method, the dielectric multilayer filter 34 is formed on the transparent base 33 by sputtering using the sputtering apparatus 42 too.

According to the third manufacturing method, only one of the pair of cathodes 45 and 46 is used. One kind of metal target is attached to one of the cathodes 45 and 46. The reaction gas used when the first dielectric thin film 37 is formed differs from the reaction gas used when the second dielectric thin film 38 is formed. The third manufacturing method provides thin films with different refractive indexes by changing the reaction gas.

For example, metal silicon (Si) is used as a target material for the metal target and one of oxygen, nitrogen, hydrogen or a mixture of oxygen and nitrogen is used as the reaction gas. The third manufacturing method provides thin films with the following refractive indexes.

An SiOx thin film (refractive index n≈1.45) is acquired when the reaction gas is oxygen, and an SiNy thin film (refractive index n≈1.8) is acquired when the reaction gas is nitrogen. An SiHz thin film (refractive index n≈3.8) is acquired when the reaction gas is hydrogen, and an SiOm Nn thin film (refractive index 1.45<n<1.8) is acquired when the reaction gas is a mixture of oxygen and nitrogen.

In the third gain equalizer manufacturing method, the target material is metal silicon (Si), the reaction gas for forming the first dielectric thin film 37 is oxygen, and the reaction gas for forming the second dielectric thin film 38 is a mixture of oxygen and nitrogen, for example.

The third gain equalizer manufacturing method has the following advantages.

(1) One kind of metal target (Si) is attached to one cathode. The type of the reaction gas is changed between the deposition of the first dielectric thin film 37 and the deposition of the second dielectric thin film 38. For example, oxygen is used in reactive sputtering when the first dielectric thin film 37 is formed whereas a mixture of oxygen and nitrogen is used in reactive sputtering when the second dielectric thin film 38 is formed. Therefore, the first and second dielectric thin films 37 and 38 whose refractive index difference Δn lies within a predetermined range can alternately be laminated on the transparent base 33, advantageously.

(2) By properly changing the composition ratio of the gas mixture, e.g., the gas mixture of oxygen and nitrogen, the refractive index difference Δn can be adequately changed within a predetermined range.

[Gain-Equalizer Equipped Collimator]

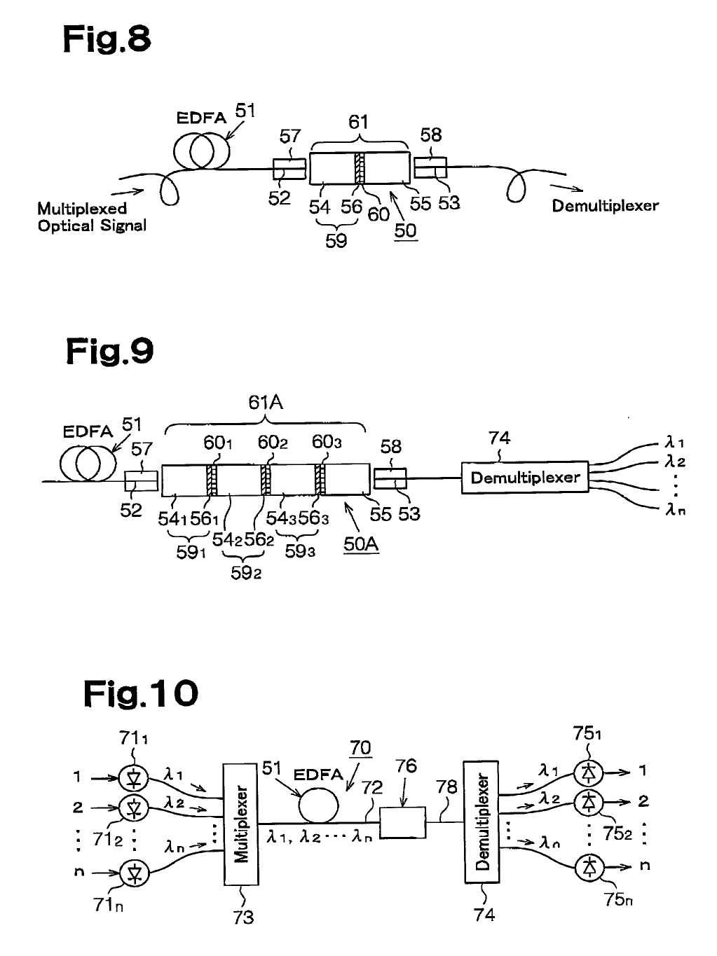

A first gain-equalizer equipped collimator 50 will now be described referring to FIG. 8. The first gain-equalizer equipped collimator 50 includes a gain equalizer 61 which has a single minus filter 59 and a light-reception side collimator lens 55.

The first gain-equalizer equipped collimator 50 has a dielectric multilayer filter 56 arranged between a pair of collimator lenses 54 and 55 that couple a multiplexed optical signal amplified by an EDFA (Er doped optical amplifier) 51 and output from an incident side single-mode optical fiber 52 to a reception side single-mode optical fiber 53. The dielectric multilayer filter 56, like the dielectric multilayer filter 34 in FIG. 3, has a predetermined number m of alternate laminations of the first dielectric thin films 37 having a relatively high refractive index and the second dielectric thin films 38 whose refractive index is slightly lower than that of the first dielectric thin films 37. Capillaries 57 and 59 respectively hold the single-mode optical fibers 52 and 53.

The single minus filter 59 of the gain equalizer 61 includes the incident side collimator lens (transparent base) 54 which converts light from the incident side single-mode optical fiber 52 to parallel light, and the dielectric multilayer filter 56 formed on the flat end face (one surface) of the collimator lens 54. The minus filter 59, like the minus filter 35 in FIG. 3, has a desired optical performance (reflectance) in a narrow reflection band corresponding to a specific gain peak in a plurality of gain peaks included in the gain spectrum shown in FIG. 1A.

The reception side collimator lens (equivalent to the incidence medium 36 of the gain equalizer 31) 55 couples parallel light to the reception side single-mode optical fiber 53. The flat end face of the collimator lens 55 is adhered to the surface of the dielectric multilayer filter 56 by an adhesive 60. The collimator lenses 54 and 55 are, for example, cylindrical microlenses which are radial gradient index rod lenses.

The first gain-equalizer equipped collimator 50 has the following advantages.

(1) The gain equalizer 61 is integrated with the collimator 50. As the collimator 50 is attached between optical fibers (incident side and reception side optical fibers located in front and at the back of an optical amplifier of a WDM transmission apparatus, therefore, the gain spectrum of the optical amplifier is compensated.

At the time the collimator 50 is connected between optical fibers, the optical axis of the incident side collimator lens has only to be matched with the axial center of the incident side single-mode optical fiber, and the optical axis of the reception side collimator lens has only to be matched with the axial center of the reception side single-mode optical fiber. This facilitates the attachment of the collimator 50 to the WDM transmission apparatus.

(2) The multiplexed optical signal that is output from the incident side single-mode optical fiber 52 to the collimator 50 is coupled to the reception side single-mode optical fiber 53 after the gain spectrum of the EDFA 51 is adequately flattened.

A second gain-equalizer equipped collimator 50A will now be described referring to FIG. 9.

Like the gain equalizer 31B of the third embodiment shown in FIG. 5, the second gain-equalizer equipped collimator 50A includes a gain equalizer 61A having three minus filters 59₁, 59₂ and 59₃. The three minus filters 59₁, 59₂ and 59₃ have desired reflection characteristics in wavelength bands respectively corresponding to three gain peaks (peak wavelengths of 1531 nm, 1545 nm and 1554 nm) included in the gain spectrum in FIG. 1A.

The minus filter 59₁ includes a collimator lens (transparent base) 54₁ and a dielectric multilayer filter 56₁ formed on the flat end face of the collimator lens 54₁. The minus filter 59₂ includes a collimator lens (transparent base) 54₂ and a dielectric multilayer filter 56₂ formed on the flat end face of the collimator lens 54₂. The minus filter 59₃ includes a collimator lens (transparent base) 54₃ and a dielectric multilayer filter 56₃ formed on the flat end face of the collimator lens 54₃.

The four collimator lenses 54₁, 54₂, 54₃ and 55 are arranged in such a way that their optical axes coincide with one another. The three minus filters 59₁ to 59₃ are connected (arranged) vertically along the optical axes of the individual collimator lenses. The dielectric multilayer filter 56₁ is adhered to the collimator lens 54₂ by an adhesive 60₁. The dielectric multilayer filter 56₂ is adhered to the collimator lens 54₃ by an adhesive 60₂. The dielectric multilayer filter 56₃ is adhered to the collimator lens 55 by an adhesive 60₃.

The flat surface of the collimator lens 55 which is equivalent to the incidence medium 36 of the gain equalizer 31B is adhered to the surface of the dielectric multilayer filter 56₃ formed on the end face of the collimator lens 54₃ by an adhesive 60₃. The single-mode optical fiber 53 is connected to a demultiplexer 74 which demultiplexes a multiplexed optical signal λ₁ to λₙ wavelength by wavelength to acquire n optical signals.

The second gain-equalizer equipped collimator 50A has the following advantages.

(1) The gain equalizer 61A of the second gain-equalizer equipped collimator 50A includes the three minus filters 59₁ to 59₃ which have desired reflection characteristics (loss spectra) in three different wavelength bands. As the loss spectra of the three minus filters are combined, a loss spectrum which compensates for a gain spectrum as shown in FIG. 1A can be generated. The combined loss spectrum can flatten the gain spectrum to compensate for the wavelength dependency of the gain of the EDFA. As a result, a gain spectrum after equalization as shown in FIG. 1D, for example, is acquired.

Therefore, the multiplexed optical signal input to the second gain-equalizer equipped collimator 50A is coupled to the reception side single-mode optical fiber 53 after the gain spectrum of the EDFA 51 is adequately flattened in the reflection band. At this time, the intensity of the optical signal in the transmission band does not drop. As a result, amplified light which does not have a wavelength-dependent intensity deviation can be acquired over a wide wavelength band by the reception side single-mode optical fiber 53.

(2) It is possible to compensate for gain spectra with complex shapes by adequately changing the loss spectra of the three minus filters.

The number of the minus filters 59 is not limited to three, but may be two or four or greater.

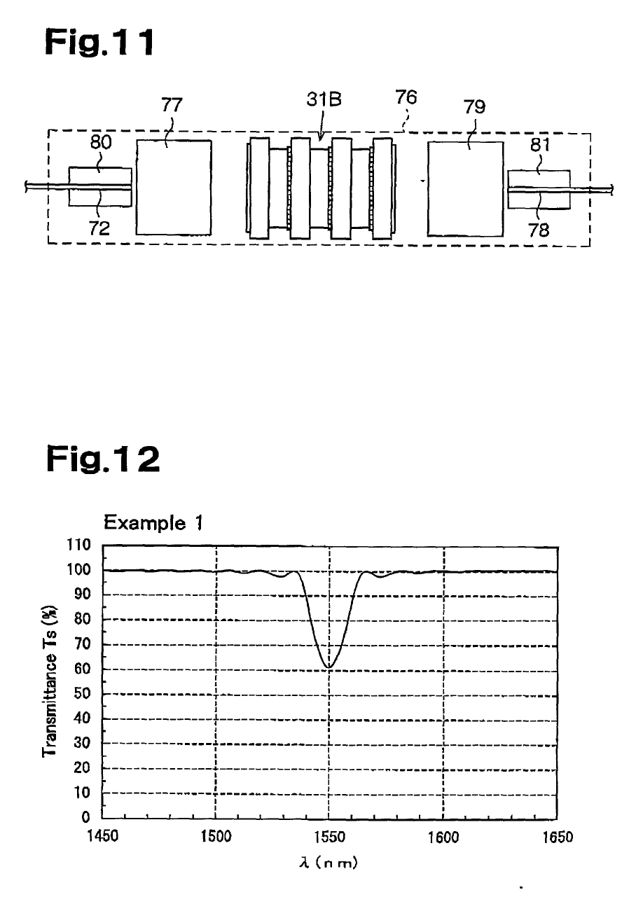

A WDM transmission apparatus 70 which uses a gain equalizer will now be described referring to FIGS. 10 and 11. The WDM transmission apparatus 70 includes the gain equalizer 31B in FIG. 5.

The WDM transmission apparatus 70 shown in FIG. 10 includes n light sources 71₁, 71ₙ, . . . , and 71ₙ which respectively output optical signals λ₁ to λₙ of different wavelengths, and a multiplexer 73 which multiplexes the optical signals λ₁ to λₙ and couples the resultant multiplexed optical signal to a single-mode optical fiber 72. The n light sources 71₁, . . . , and 71ₙ are, for example, a laser diode array.

The WDM transmission apparatus 70 further includes the EDFA 51 which amplifies the multiplexed optical signal λ₁-λₙ and the demultiplexer 74 which demultiplexes the multiplexed optical signal λ₁-λₙ wavelength by wavelength to acquire n optical signals. The n optical signals separated by the demultiplexer 74 are received at n light receiving portions 75₁, 75₂, . . . and 75ₙ via n single-mode optical fibers, respectively. The n light receiving portions 75₁, 75₂, . . . , and 75ₙ are, for example, a photodetector array.

The WDM transmission apparatus 70 further has a gain equalization module 76 located between the EDFA 51 and the demultiplexer 74. As shown in FIG. 11, the gain equalization module 76 includes a collimator lens 77 which converts a multiplexed optical signal amplified by the EDFA 51 and output from the single-mode optical fiber 52 to parallel light, the gain equalizer 31B, and a collimator lens 79 which condenses the parallel light and couples the light to a reception side single-mode optical fiber 78. The gain equalizer 31B is located in a parallel light path between the collimator lenses 77 and 79. The gain equalization module 76 further includes capillaries 80 and 81 which respectively hold the single-mode optical fibers 52 and 78.

The WDM transmission apparatus 70 using the gain equalizer has the following advantage.

The multiplexed optical signal that is amplified by the EDFA 51 and output from the incident side single-mode optical fiber 52 to the gain equalization module 76 can be coupled to the reception side single-mode optical fiber 53 after the gain spectrum of the EDFA 51 is adequately flattened in the reflection band by the gain equalizer 31B. Consequently, amplified light that is free of a wavelength-dependent intensity deviation can be acquired over a wide wavelength band, which is advantageous in a WDM transmission type optical communication system.

### [EXAMPLE 1]

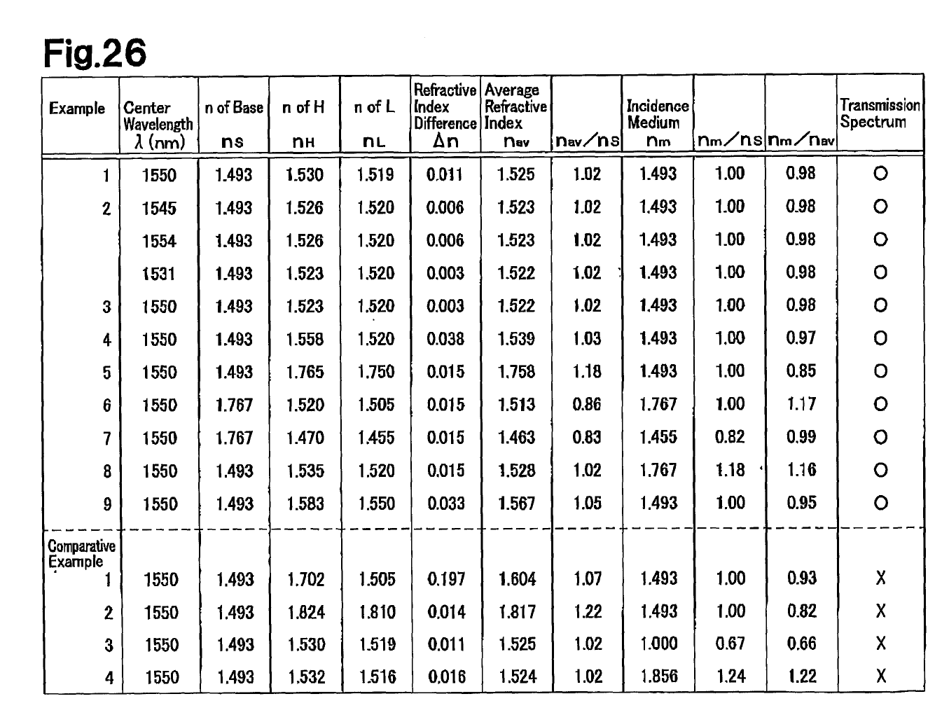

Example 1 of the gain equalizers 31 and 31A shown in FIGS. 3 and 4 will be discussed below with reference to FIGS. 10 and 26.

(Preparation of Minus Filter 35)

The pair of cathodes 45 and 46 are arranged close to each other and sputtering powers are independently supplied to the cathodes by using the carousel type sputtering apparatus 42 shown in FIGS. 6 and 7 as done in the first manufacturing method.

The metal targets used are titanium (Ti) and boron doped silicon (Si:B). The discharge gas used is a mixture of oxygen and argon gas.

As the two targets are discharged at a time by simultaneously supplying powers to the cathodes 45 and 46, a dielectric thin film containing a mixture of titanium oxide (TiO₂) and silicon oxide (SiO₂) is deposited on the glass substrate (transparent base) 33 mounted on the holder (carousel) 44. The glass substrate in use was “BK7” (a product of Schott) of100mm×100 mm×1 mm (thickness).

The sputtering was performed under the conditions of the rotational speed of the holder 44 of 200 min⁻¹, the oxygen gas flow rate of 40 cm³/min, the argon gas flow rate of 10 cm³/min and the full gas pressure of 0.66 Pa (5×10⁻³ Torr). The glass substrate was not subjected to a heat treatment at the time of film deposition.

The refractive indexes of the first and second dielectric thin films 37 and 38 of the dielectric multilayer filter 34 were set by controlling the sputter rates of the individual metal targets by the adjustment of the sputtering powers to the cathodes 45 and 46 and by adjusting the composition ratios of the TiO₂ component and SiO₂ component in the mixed dielectric thin film formed on the glass substrate.

In forming the mixed dielectric thin film, the relationship between the sputtering powers to be supplied to the cathodes 45 and 46 and the refractive indexes of the dielectric thin film to be obtained was determined by conducting experimental deposition beforehand. In accordance with the determined relationship, the respective cathodes were provided with the sputtering powers.

The experimental deposition was carried out as follows. First, five levels were set as the values of powers to be supplied to the cathodes 45 and 46 under the sputtering conditions. A single mixed dielectric thin film was formed on the glass substrate ten times as the power to be supplied to each cathode was changed in accordance with the five levels. In each deposition, the refractive index of the single mixed dielectric thin film formed on the glass substrate was measured by a spectroscopic ellipsometry. The relationship between the sputtering power to be supplied to each cathode and the refractive index of the mixed dielectric thin film to be obtained was grasped from the results of ten measurements.

The control on the thicknesses of the first and second dielectric thin films 37 and 38 was executed while monitoring the transmittance of the glass substrate by a direct view type optical monitor. The direct view type optical monitor can directly measure the transmittance of the glass substrate mounted on the sputtering apparatus 42 even during deposition.

The sputtering powers to be supplied to the individual cathodes were set in accordance with the experimental results and sputtering was carried out in such a way that the first and second dielectric thin films 37(H) and 38(L) having refractive indexes given below would be laminated on the glass substrate (see data on Example 1 shown in FIG. 26).

Refractive index (n_{H}) of H: 1.530

(value at λ=1550 nm)

Refractive index (n_{L}) of L: 1.519

(value at λ=1550 nm)

Refractive index difference Δn: 0.011

In Example 1, the center wavelength λ in the reflection band was λ=1550 nm and the minus filter 35 having a structure of “glass substrate (transparent base)/(HL)₁₀₀/glass substrate (incidence medium)” was prepared. The refractive index (n₃) of the glass substrate (BK7) is 1.493 (see FIG. 26). In the following description of the examples and comparative examples of the invention, the center wavelength λ in the reflection band is λ=1550 nm unless otherwise specified.

(Adherence to Glass Substrate)

To make the refractive index nₘ of the glass substrate (incidence medium) 36 of the minus filter 35 equal to the average refractive index nₐᵥ of the dielectric multilayer filter 34 or the refractive index nₛ of the glass substrate (transparent base) 33, the glass substrate 36 was adhered through the following procedures.

An ultraviolet curing adhesive (n=1.511) 39 was applied to the surface of the dielectric multilayer filter 34, the glass substrate (BK7) of the same type and same shape as those of the glass substrate used for the transparent base 33 was adhered to sandwich the dielectric multilayer filter 34 with the same two glass substrates. Under the situation, ultraviolet rays were irradiated on the ultraviolet curing adhesive 39 to adhere the glass substrate (incidence medium) 36 to the surface of the dielectric multilayer filter 34.

In the following description of the examples and comparative examples of the invention, the glass substrate is adhered to the surface of the dielectric multilayer filter of the minus filter by using an ultraviolet curing adhesive unless otherwise specified.

(Deposition of Antireflection Films)

Antireflection films were respectively formed on the outer surfaces of the two glass substrates 33 and 36 as follows.

The antireflection films 40 and 41 having a structure of TiO₂ (64.1 nm)/SiO₂ (60.8 nm)/TiO₂ (218.7 nm)/SiO₂ (258.7 nm) were respectively formed on the outer surfaces of the glass substrates 33 and 36 by electron beam vacuum deposition. The antireflection films 40 and 41 suppressed the surface reflectances on both sides of the gain equalizer 31A shown in FIG. 4 to 0.2% or lower in the wavelength band of λ=1550 nm±50 nm. In the following description of the examples and comparative examples of the invention, antireflection films are likewise formed on the outer surfaces of two glass substrates unless otherwise specified.

The optical characteristic (reflection characteristic) of the prepared gain equalizer was evaluated by an optical spectrum analyzer using an LED light source. In the following description of the examples and comparative examples of the invention, the evaluation of the reflection characteristic of the gain equalizer was carried out by an optical spectrum analyzer using an LED light source.

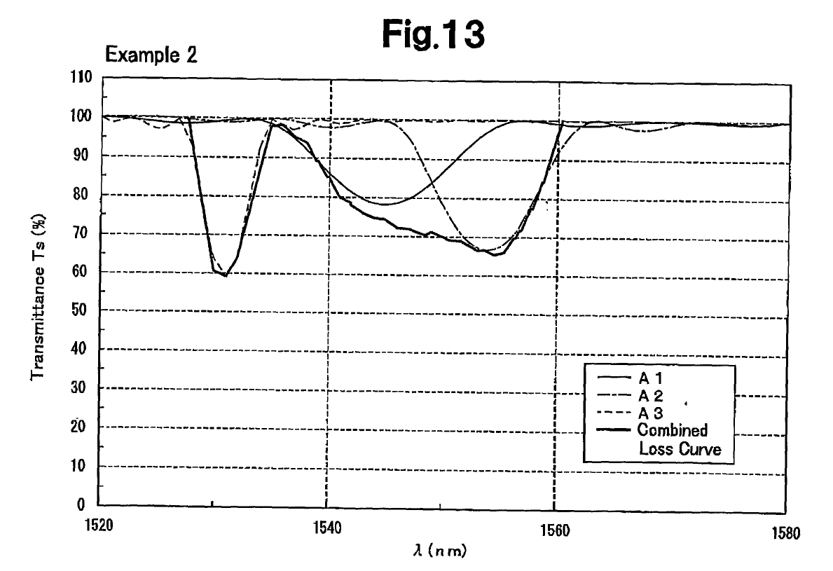

The gain equalizer of Example 1 provides a transmission spectrum shown in FIG. 12. As shown in FIG. 12, the reflection band was approximately 30 nm, the transmittance in the reflection band was approximately 60%, the transmittance in the transmission band other than the reflection band was 100% and there were very few ripples in the transmission band. The gain equalizer can be adapted to a WDM transmission system. Marks ◯ in the column of the transmission spectrum in FIG. 26 indicate an adaptable state.

### [EXAMPLE 2]

Example 2 of the gain equalizer 31B shown in FIG. 5 will be discussed below with reference to FIGS. 13 and 26.

In Example 2, three minus filters 35₁, 35₂ and 35₃ respectively having center wavelengths λ of 1545 nm, 1554 nm and 1531 nm in the reflection band were prepared and were adhered in series (vertically) to prepared the gain equalizer 31B.

The sputtering powers to be supplied to the individual cathodes were set in accordance with the experimental results and sputtering was executed by using the results of the experimental deposition of Example 1 in such a way that the first and second dielectric thin films 37 and 38 having refractive indexes given below would be laminated on the glass substrate (see data on Example 2 shown in FIG. 26).

Refractive index (n₄) of H: 1.526

(value at λ=1545 nm)

Refractive index (n_{L}) of L: 1.520

(value at λ=1545 nm)

Refractive index difference Δn: 0.006

In Example 2, the center wavelength λ in the reflection band was λ=1545 nm and a minus filter A1 having a structure of “glass substrate/(HL)₁₂₅” was prepared.

To evaluate the optical performance of the minus filter A1, a glass substrate was adhered to the surface of the dielectric multilayer filter of the minus filter A1 by using an ultraviolet curing adhesive. The transmission spectrum of the minus filter A1 is indicated by a curve A1 in FIG. 13.

The sputtering powers to be supplied to the individual cathodes were set in accordance with the experimental results and sputtering was executed by using the results of the experimental deposition of Example 1 in such a way that the first and second dielectric thin films 37 and 38 having refractive indexes given below would be laminated on the glass substrate (see data on Example 2 shown in FIG. 26).

Refractive index (n_{H}) of H. 1.526

(value at λ—1554 nm)

Refractive index (n_{L}) of L: 1.520

(value at λ—1554 nm)

Refractive index difference Δn: 0.006

In Example 2, the center wavelength λ in the reflection band was λ=1554 nm and a minus filter A2 having a structure of “glass substrate/(HL)₁₆₅” was prepared. To evaluate the optical performance of the minus filter A2, the minus filter A2 with antireflection films was prepared as per the minus filter A1. The transmission spectrum of the antireflection-film provided minus filter A2 is indicated by a curve A2 in FIG. 13.

The sputtering powers to be supplied to the individual cathodes were set in accordance with the experimental results and sputtering was executed by using the results of the experimental deposition of Example 1 in such a way that the first and second dielectric thin films 37 and 38 having refractive indexes given below would be laminated on the glass substrate (see data on Example 2 shown in FIG. 26).

Refractive index (n_{H}) of H: 1.523

(value at λ=1531 nm)

Refractive index (n_{L}) of L: 1.520

(value at λ=1531 nm)

Refractive index difference Δn: 0.003

In this example, the center wavelength λ in the reflection band was λ=1531 nm and a minus filter A3 having a structure of “glass substrate/(HL)₃₇₅” was prepared. To evaluate the optical performance of the minus filter A3, the antireflection-film provided minus filter A3 was prepared as per the minus filter A1. The transmission spectrum of the antireflection-film provided minus filter A3 is indicated by a curve A3 in FIG. 13.

Next, the three minus filters 35₁, 35₂ and 35₃ shown in FIG. 5 were prepared by laminating the first and second dielectric thin films 37 and 38 respectively having the same refractive indexes as those of the minus filters A1, A2 and A3 on the respective glass substrates (transparent bases 33₁, 33₂ and 33₃ shown in FIG. 5). Then, the three minus filters 35₁, 35₂ and 35₃ were respectively adhered to the three glass substrates by the adhesives 39₁, 39₂ and 39₃ as shown in FIG. 5, thereby preparing the gain equalizer 31B.

The reflection spectrum of the gain equalizer 31B is indicated by the combined loss curve in FIG. 13. It was confirmed that the reflection spectrum indicated by the combined loss curve, which was the transmission spectra of the three minus filters A1, A2 and A3 combined together, would cancel out (compensate) the gain spectrum of the EDFA.

### [EXAMPLE 3]

In Example 3, the sputtering powers to be supplied to the individual cathodes were set in accordance with the experimental results and sputtering was executed in the same way as done in Example 1 in such a way that the first and second dielectric thin films 37 and 38 having refractive indexes given below would be laminated on the glass substrate (see data on Example 3 shown in FIG. 26).

Refractive index (n_{H}) of H: 1.523

(value at λ=1550 nm)

Refractive index (n_{L}) of L: 1.520

(value at λ=1550 nm)

Refractive index difference Δn: 0.003

In Example 3, a minus filter having a structure of “glass substrate/(HL)₂₅₀” was prepared.

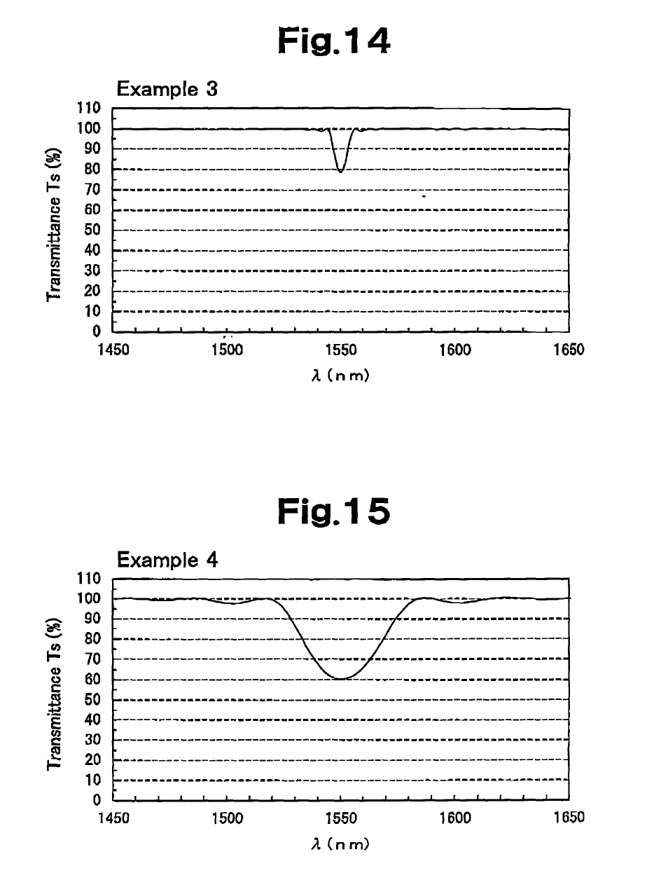

The gain equalizer of Example 3 provided a transmission spectrum shown in FIG. 14. As shown in FIG. 14, the reflection band was approximately 10 nm, the transmittance in the reflection band was approximately 80%, the transmittance in the transmission band was 100% and there were very few ripples in the transmission band.

Because Example 3 had a small refractive index difference Δn of 0.003, the reflection characteristic of a narrow reflection band of about 10 nm was acquired. While the transmittance in the reflection band became slightly high, the transmittance of the reflection band could be made lower by increasing the lamination number of the dielectric multilayer filter.

### [EXAMPLE 4]

In Example 4, the sputtering powers to be supplied to the individual cathodes were set in accordance with the experimental results and sputtering was executed in the same way as done in Example 1 in such a way that the first and second dielectric thin films 37 and 38 having refractive indexes given below would be laminated on the glass substrate (see data on Example 4 shown in FIG. 26).

Refractive index (n_{H}) of H: 1.558

(value at λ=1550 nm)

Refractive index (n_{L}) of L: 1.520

(value at λ=1550 nm)

Refractive index difference Δn: 0.038

In Example 3, a minus filter having a structure of “glass substrate/(HL)₃₀” was prepared.

The gain equalizer of Example 4 provided a transmission spectrum shown in FIG. 15. As apparent from FIG. 15, the reflection band was approximately 100 nm, the transmittance in the reflection band was approximately 60%, the transmittance in the transmission band was 100% and there were very few ripples in the transmission band.

Because Example 4 has a large refractive index difference Δn of 0.038, the reflection band was broadened.

### [EXAMPLE 5]

In Example 5, the sputtering powers to be supplied to the individual cathodes were set in accordance with the experimental results and sputtering was executed in the same way as done in Example 1 in such a way that the first and second dielectric thin films 37 and 38 having refractive indexes given below would be laminated on the glass substrate (see data on Example 5 shown in FIG. 26).

Refractive index (n_{H}) of H: 1.765

(value at λ=1550 nm)

Refractive index (n_{L}) of L: 1.750

(value at λ=1550 nm)

Refractive index difference Δn: 0.015

In Example 5, the average refractive index nₐᵥ of the dielectric multilayer filter was set to 1.758 (1.18 times the refractive index of the glass substrate (transparent base) (nₛ=1.493)). A minus filter having a structure of “glass substrate/(HL)₁₀₀” was prepared.

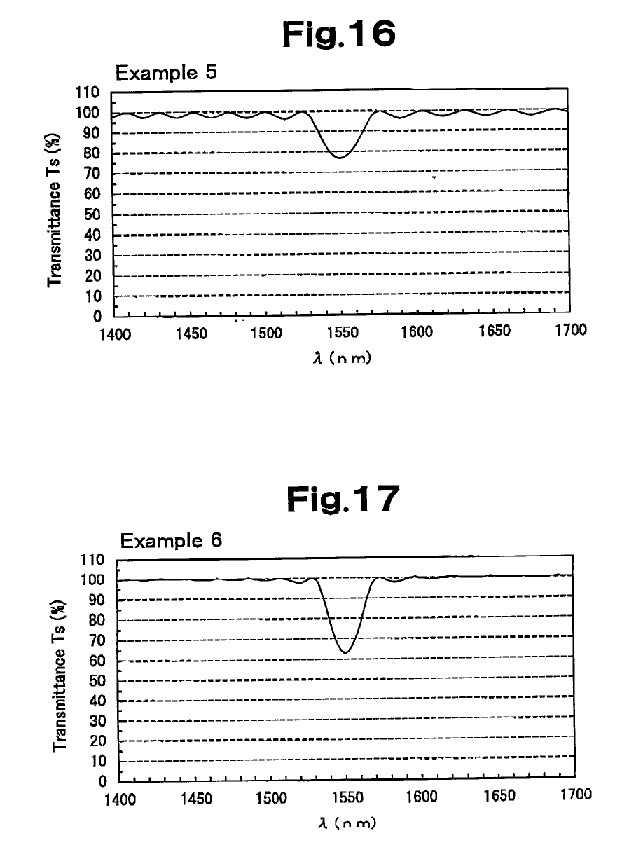

The gain equalizer of Example 5 provided a transmission spectrum shown in FIG. 16. As shown in FIG. 16, the reflection band was approximately 50 nm, the transmittance in the reflection band was approximately 75%, few ripples were produced in the entire transmission band and the transmission loss caused by the ripples were about 3%.

Because the dielectric multilayer filter in Example 5 had a large average refractive index of about 1.2 times the refractive index (n_{H}) of the glass substrate (transparent base), few ripples were produced.

### [EXAMPLE 6]

In Example 6, a glass substrate (“SFL-6” produced by Matsunami Glass Ind.) having a refractive index of 1.767 was used. The sputtering powers to be supplied to the individual cathodes were set in accordance with the experimental results and sputtering was executed in the same way as done in Example 1 in such a way that the first and second dielectric thin films 37 and 38 having refractive indexes given below would be laminated on the glass substrate (see data on Example 6 shown in FIG. 26).

Refractive index (n_{H}) of H: 1.520

(value at λ=1550 nm)

Refractive index (n_{L}) of L: 1.505

(value at λ=1550 nm)

Refractive index difference Δn: 0.015

In Example 6, the average refractive index nₐᵥ was set to 1.513 (0.85 times the refractive index of the glass substrate (transparent base) (nₛ=1.767)). A minus filter having a structure of “glass substrate/(HL)₇₀” was prepared. A glass substrate (incidence medium) having a refractive index nₘ of 1.767 was adhered to the surface of the dielectric multilayer filter of the minus filter by an ultraviolet curing adhesive.

The gain equalizer of Example 6 provided a transmission spectrum shown in FIG. 17. As shown in FIG. 17, the reflection band is approximately 40 nm, and the transmittance in the reflection band is approximately 60%. Although few ripples were produced in the vicinity of the reflection band, the ripples originated transmission loss was of an insignificant order.

Because the dielectric multilayer filter in Example 6 had a small average refractive index of about 0.85 times the refractive index nₛ of the glass substrate (transparent base), few ripples were produced.

### [EXAMPLE 7]

In Example 7, a glass substrate (“SFL-6” produced by Matsunami Glass Ind.) having a refractive index of 1.767 was used. The sputtering powers to be supplied to the individual cathodes were set in accordance with the experimental results and sputtering was executed in the same way as done in Example 1 in such a way that the first and second dielectric thin films 37 and 38 having refractive indexes given below would be laminated on the glass substrate (see data on Example 7 shown in FIG. 26).

Refractive index (n_{H}) of H: 1.470

(value at λ=1550 nm)

Refractive index (n_{L}) of L: 1.455

(value at λ=1550 nm)

Refractive index difference Δn: 0.015

In Example 7, a minus filter having a structure of “glass substrate/(HL)₇₀” was prepared. A quartz glass substrate (incidence medium) having a refractive index nₘ of 1.455 was adhered to the surface of the dielectric multilayer filter of the minus filter by an ultraviolet curing adhesive.

The gain equalizer of Example 7 provided a transmission spectrum shown in FIG. 18. As shown in FIG. 18, the reflection band is approximately 50 nm, and the transmittance in the reflection band is approximately 70%. Few ripples were produced in the vicinity of the reflection band, and the ripples-originated transmission loss was about 3%.

Because of the incidence medium (quartz glass substrate) had a small refractive index nₘ of about 0.8 times the refractive index nₛ of the glass substrate (transparent base), few ripples were produced.

### [EXAMPLE 8]

In Example 8, the glass substrate (BK7: transparent base) having a refractive index of 1.493 that was used in Example 1 was used. The sputtering powers to be supplied to the individual cathodes were set in accordance with the experimental results and sputtering was executed in the same way as done in Example 1 in such a way that the first and second dielectric thin films 37 and 38 having refractive indexes given below would be laminated on the glass substrate (see data on Example 8 shown in FIG. 26).

Refractive index (n_{H}) of H: 1.535

(value at λ=1550 nm)

Refractive index (n_{L}) of L: 1.520

(value at λ=1550 nm)

Refractive index difference Δn: 0.015

In Example 7, a minus filter having a structure of “glass substrate/(HL)₇₀” was prepared. A glass substrate (“SFL-6” produced by Matsunami Glass Ind.: incidence medium) having a refractive index nm of 1.767 was adhered to the surface of the dielectric multilayer filter of the minus filter by an ultraviolet curing adhesive.

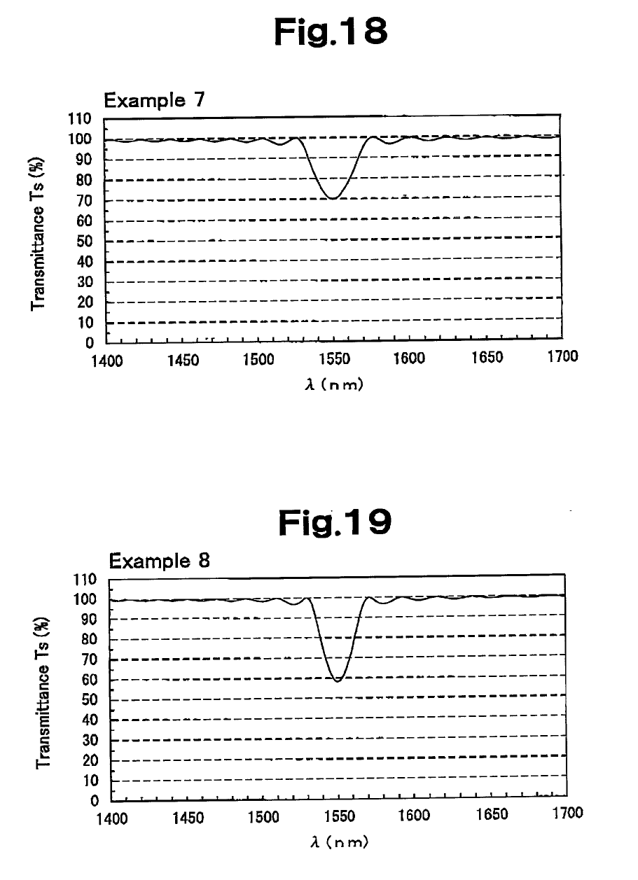

The gain equalizer of Example 8 provided a transmission spectrum shown in FIG. 19. As shown in FIG. 19, the reflection band is approximately 40 nm, and the transmittance in the reflection band is approximately 60%. Few ripples were produced near the reflection band, and the ripples-originated transmission loss was about 3%.

Because the incidence medium (glass substrate) had a large refractive index nm of about 1.2 times the refractive index nₛ of the transparent base (glass substrate), few ripples were produced.

### [EXAMPLE 9]

In Example 9, apodization was used. According to the apodization scheme, the dielectric multilayer filter is formed in such a way that the refractive index difference Δn becomes smaller as the point approaches the incidence medium and the transparent base.

In Example 9, the glass substrate of the Example 1 (BK7: transparent base) having a refractive index nₛ of 1.493 was used. The sputtering powers to be supplied to the individual cathodes were set in accordance with the experimental results and sputtering was executed in the same way as done in Example 1 in such a way that the first and second dielectric thin films 37 and 38 having refractive indexes given below would be laminated on the glass substrate (see data on Example 9 shown in FIG. 26).

Refractive index (n_{H}) of H: 1.583

(value at λ=1550 nm)

Refractive index (n_{L}) of L: 1.550

(value at λ=1550 nm)

Refractive index difference Δn: 0.033

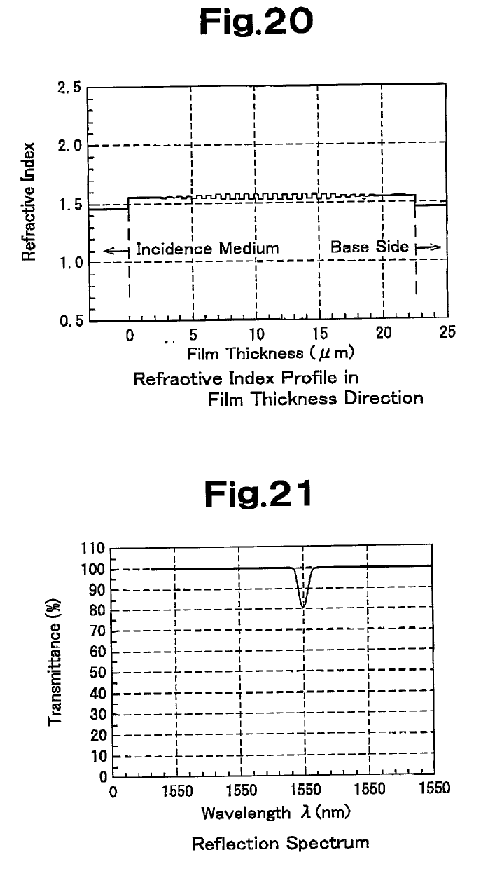

In Example 7, a minus filter having a structure of “glass substrate/(HL)₃₀” was prepared (see FIG. 20). The refractive indexes nₘ and n_{L} are the refractive indexes at the center portion of the dielectric multilayer filter in the thickness direction.

A glass substrate (BK7: transparent base) was adhered to the surface of the dielectric multilayer filter of the minus filter by an ultraviolet curing adhesive.

The gain equalizer of Example 9 provided a transmission spectrum shown in FIG. 21. As shown in FIG. 21, the reflection band is approximately 100 nm, and the transmittance in the reflection band is approximately 80%. Even though the refractive index difference Δn was large, ripples were not produced in the transmission band.

### [COMPARATIVE EXAMPLE 1]

In Comparative Example 1, the sputtering powers to be supplied to the individual cathodes were set in accordance with the experimental results and sputtering was executed in the same way as done in Example 1 in such a way that the first and second dielectric thin films 37(H) and 38(L) having refractive indexes given below would be laminated on the glass substrate (see data on Comparative Example 1 shown in FIG. 26).

Refractive index (n_{H}) of H: 1.702

(value at λ=1550 nm)

Refractive index (n_{L}) of L: 1.505

(value at λ=1550 nm)

Refractive index difference Δn: 0.197

In Example 3, a minus filter having a structure of “glass substrate/(HL):₃₀” was prepared.

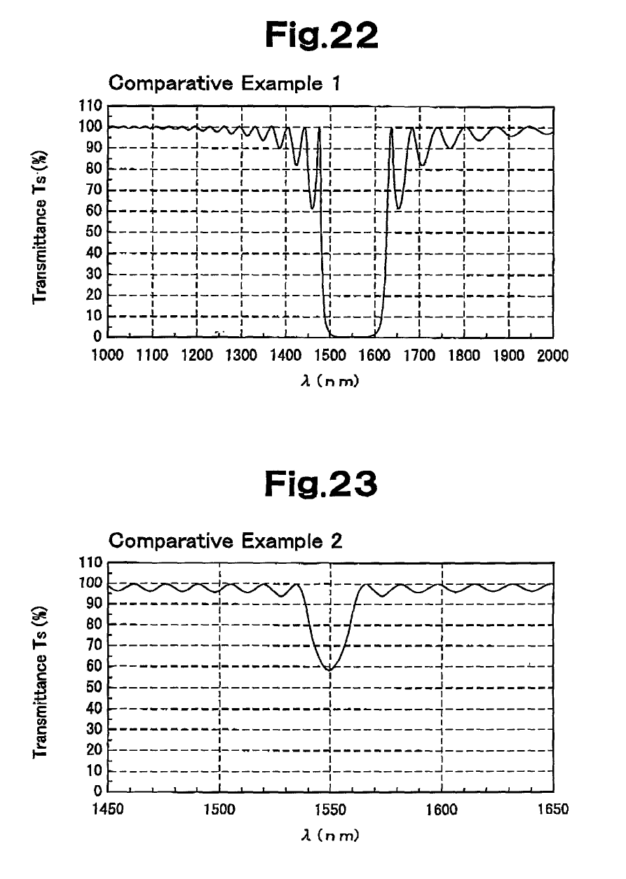

The gain equalizer of Comparative Example 1 provided a transmission spectrum shown in FIG. 22. As shown in FIG. 22, the reflection band was approximately 150 nm, and the transmittance in the reflection band was nearly 0%. Very large ripples were produced in the transmission band.

Because the refractive index difference Δn between the refractive index n_{H} and the refractive index n_{L} was approximately 0.2, off the preferable range, in Comparative Example 1, the reflection band was broadened. The gain equalizer or Comparative Example 1 cannot be adapted to a WDM transmission system. Marks X in the column of the transmission spectrum in FIG. 26 indicate an unadaptable state.

### [COMPARATIVE EXAMPLE 2]

In Comparative Example 2, the glass substrate (refractive index nₛ=1.493) as used in Example 1 was used. The sputtering powers to be supplied to the individual cathodes were set in accordance with the experimental results and sputtering was executed in the same way as done in Example 1 in such a way that the first and second dielectric thin films 37 and 38 having refractive indexes given below would be laminated on the glass substrate (see data on Comparative Example 2 shown in FIG. 26).

Refractive index (n_{H}) of H: 1.824

(value at λ=1550 nm)

Refractive index (n_{L}) of L: 1.810

(value at λ=1550 nm)

Refractive index difference Δn: 0.014

In Comparative Example 2, the average refractive index nₐᵥ was set to 1.817 (1.21 times the refractive index (nₛ=1.493) of the glass substrate (transparent base)) and a minus filter having a structure of “glass substrate/(HL)₁₀₀” was prepared.

The gain equalizer of Comparative Example 2 provided a transmission spectrum shown in FIG. 23. As shown in FIG. 23, the reflection band was approximately 30 nm, and the transmittance in the reflection band was nearly 60%, which would not raise a problem in the characteristic of the reflection band. However, very large ripples were produced in the transmission band and the ripples-originated transmission loss was about 5%. Because the dielectric multilayer filter had a large refractive index (average refractive index nₐᵥ) beyond the preferable range in Comparative Example 2, reflection at the interface between the glass substrate and the dielectric multilayer filter produced a loss, resulting in the appearance of the ripples.

### [COMPARATIVE EXAMPLE 3]

In Comparative Example 3, the sputtering powers to be supplied to the individual cathodes were set in accordance with the experimental results and sputtering was executed in the same way as done in Example 1 in such a way that the first and second dielectric thin films 37 and 38 having refractive indexes given below would be laminated on the glass substrate (see data on Comparative Example 3 shown in FIG. 26).

Refractive index (n_{H} ) of H: 1.530

(value at λ=1550 nm)

Refractive index (n_{L}) of L: 1.519

(value at λ=1550 nm)

Refractive index difference Δn: 0.011

In Comparative Example 3, a minus filter having a structure of “glass substrate/(HL)₁₀₀” was prepared. Thereafter, as in Example 1, a glass substrate (incidence medium) was not adhered to the surface of the dielectric multilayer filter but an antireflection film was formed on the outer surface of the glass substrate (transparent base), and the incidence medium was air (refractive index of 1.0).

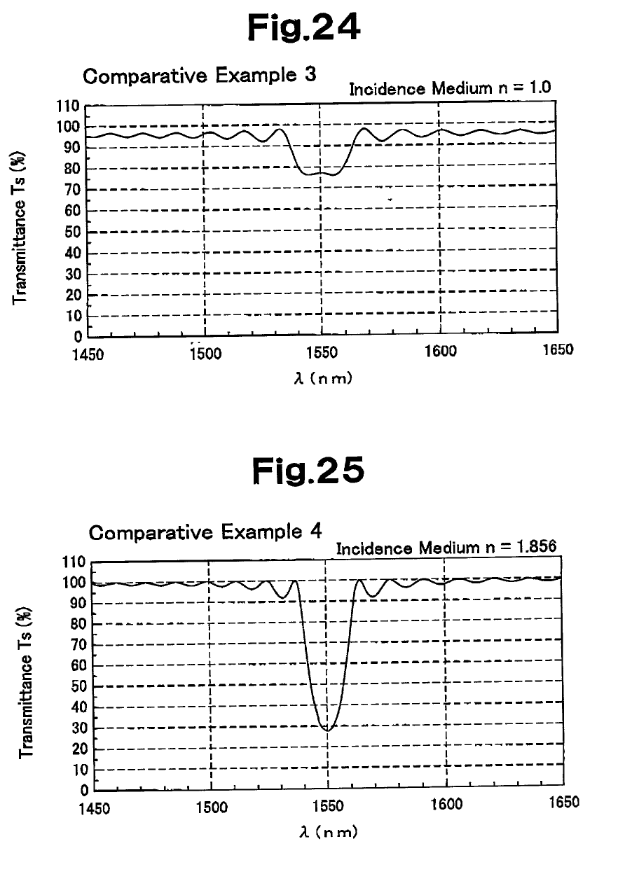

The gain equalizer of Comparative Example 3 provided a transmission spectrum shown in FIG. 24. As shown in FIG. 24, the reflection band was approximately 40 nm, and the transmittance in the reflection band was nearly 75%, which would not raise a problem in the characteristic of the reflection band. However, very large ripples were produced in the transmission band and the ripples-originated transmission loss was about 10%.

Because the incidence medium had a small refractive index (1.0) beyond the preferable range in Comparative Example 3, reflection at the surface of the dielectric multilayer filter produced a loss, resulting in the appearance of the ripples.

### [COMPARATIVE EXAMPLE 4]

In Comparative Example 4, the sputtering powers to be supplied to the individual cathodes were set in accordance with the experimental results and sputtering was executed in the same way as done in Example 1 in such a way that the first and second dielectric thin films 37 and 38 having refractive indexes given below would be laminated on the glass substrate (see data on Comparative Example 4 shown in FIG. 26).

Refractive index (n_{H} ) of H: 1.532

(value at λ=1550 nm)

Refractive index (n_{L}) of L: 1.516

(value at λ=1550 nm)

Refractive index difference Δn: 0.016

In Comparative Example 4, a minus filter having a structure of “glass substrate/(HL)₁₁₀” was prepared. Thereafter, a glass substrate (“S-LAH58” produced by Ohara Inc.: incidence medium) having a refractive index nₘ of 1,856 was adhered to the surface of the dielectric multilayer filter 34 of the minus filter by an ultraviolet curing adhesive.

The gain equalizer of Comparative Example 4 provided a transmission spectrum shown in FIG. 25. As shown in FIG. 25, the reflection band was approximately 30 nm, and the transmittance in the reflection band was nearly 30%, which would not raise a problem in the characteristic of the reflection band. However, very large ripples were produced in the transmission band and the ripples-originated transmission loss was about 10%.

In Comparative Example 4, the refractive index nₘ of the incidence medium is 1.24 times the refractive index nₛ of the transparent base or the refractive index (average refractive index nₐᵥ) of the dielectric multilayer filter, beyond the preferable range. Therefore, reflection at the interface between the incidence medium and the dielectric multilayer filter produced a loss, resulting in the appearance of the ripples.

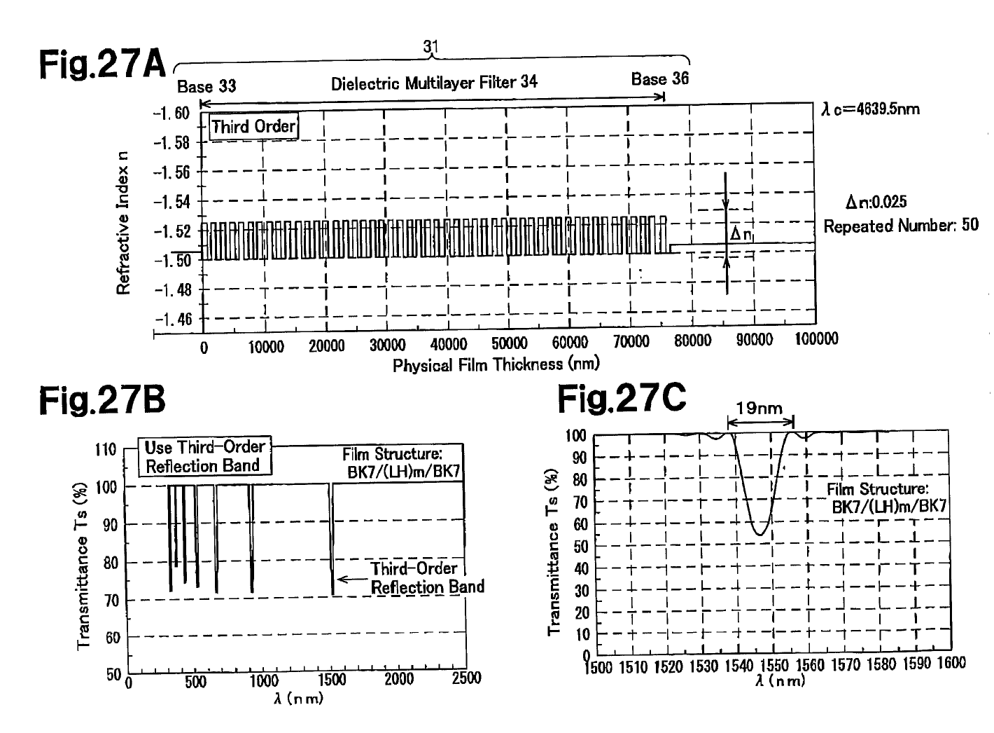

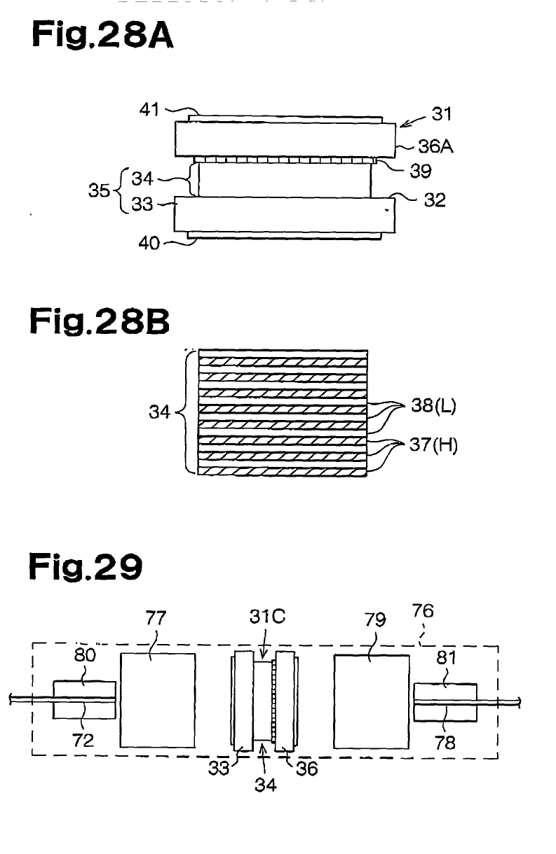

A gain equalizer 31C according to the fourth embodiment will be discussed below with reference to FIGS. 28A and 28B. The gain equalizer 31C is substantially identical to the gain equalizer 31A of the second embodiment in FIG. 4 except for the structure of the dielectric multilayer filter 34. FIG. 27A shows the film structure of the gain equalizer 31C, FIG. 27B shows the third-order reflection band and FIG. 27C shows a part of the gain equalizer in FIG. 27B in enlargement.

As shown in FIG. 28A, the gain equalizer 31C includes the single minus filter 35. The minus filter 35 includes the transparent base 33 having the flat surface 32 and the dielectric multilayer filter 34 formed on the flat surface 32.

The minus filter 35 of the gain equalizer 31C is formed in such a way that the third-order (high-order) reflection band appears at the position of the wavelength λ₀ corresponding to one of gain peaks (peak wavelengths) of the gain spectrum in FIG. 1A. The gain equalizer 31C flattens the gain spectrum using the third-order reflection band. The wavelength λ₀ is 1546.5 nm and the minus filter 35 corresponding to the center peak in the gain spectrum is prepared.

A glass substrate (“BK7”, a product of Schott: first transparent base) 33 is used. A second transparent base (BK7) 36A of the same material as that of the first transparent base 33 is adhered to the surface of the dielectric multilayer filter 34 by an adhesive. The dielectric multilayer filter 34 and the second transparent base 36A may be adhered together by, for example, optical contact, without using an adhesive.

As shown in FIG. 28B, the dielectric multilayer filter 34 has a predetermined number (repeated number) of alternate laminations of the first dielectric thin films 37 having a relatively large refractive index and the second dielectric thin films 38 having a smaller refractive index than the refractive index of the dielectric thin films 37. The dielectric multilayer filter 34 is prepared in such a way that a reflection band (reflection characteristic) of about 19 nm and having a transmittance of about 53% is obtained at the position of the wavelength λ₀ (λ₀=1546.5 nm) as shown in FIG. 27C.

The structure of the gain equalizer 31C is expressed as follows.

“transparent base/(HL)ₘ/transparent base” where the lamination quantity m is 50.

The minus filter 35 is formed in such a way that the third-order reflection band (see FIG. 27B) appears at the position of the wavelength λ₀ (λ₀1546.5 nm). In a case where the third-order reflection band with the wavelength λ₀=1546.5 nm is used, the designed wavelength λ_{c} is set to 4639.5 nm (1.546.5 nm×3) and the optical film thickness of the first and second dielectric thin films 37 and 38 of the dielectric multilayer filler 34 its set λ_{c}/4. The first-order, reflection band (not shown) having a center wavelength of 4639.5 nm is formed.

As the minus filter 35 has the reflection band shown in FIG. 27C, the refractive index difference Δn (Δn=n_{H}−n_{L}) between the refractive indexes of the first and second dielectric thin films 37 and 38 is set to Δn=0.025 and the lamination quantity (repeated number) m of the first and second dielectric thin films 37 and 38 is set equal to 50 (see FIG. 27A).

The gain equalizer 31C is adaptable to the WDM transmission apparatus shown in FIG. 10. FIG. 29 is a schematic structural diagram of the gain equalization module 76 in a case where the gain equalizer 31C is adapted to the WDM transmission apparatus.

The gain equalizer 31C according to the fourth embodiment has the following advantages.

(1) The minus filter 35 of the gain equalizer 31C is formed in such a way that the third-order reflection band appears at the position of the wavelength λ₀ (λ₀=1546.6 nm) and the gain spectrum is flattened using the third-order reflection band. This makes it possible to increase the refractive index difference Δn (Δn=0.025) and decrease the lamination quantity m of the dielectric thin films 37 and 38.

Because the refractive index difference Δn can be relatively large, a variation in the refractive indexes of the dielectric thin films 37 and 38 (n_{H}, n_{L}) can be allowed. This facilitates the refractive index control of the dielectric thin films 37 and 38, thus making it easier to prepare the dielectric multilayer filter 34.

As the lamination quantity m of the dielectric thin films 37 and 38 can be reduced, the time for preparing the dielectric multilayer filter 34 can be shortened. This results in a lower manufacturing cost.

(2) The refractive index of the medium (transparent base) that contacts the dielectric multilayer filter 34 should be considered in designing the minus filter. In the gain equalizer 31C, the dielectric multilayer filter 34 is sandwiched by the transparent bases 33 and 36A of the same material as shown in FIG. 28A. This makes the design of the film structure easier than that in the case where the refractive indexes of the transparent bases 33 and 36A differ from each other.

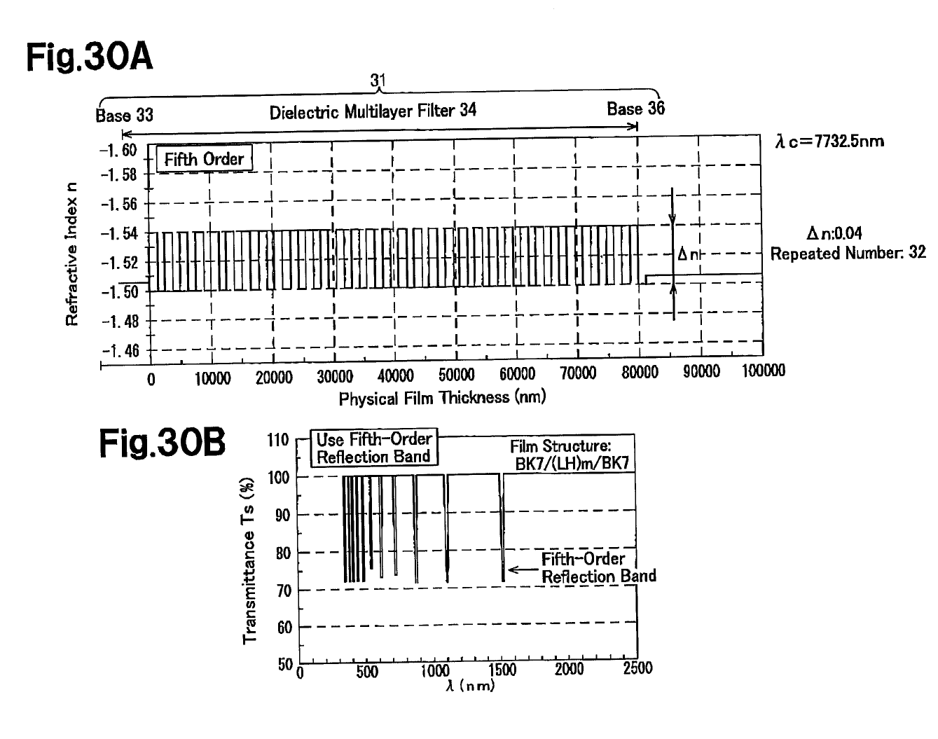

A gain equalizer 31D according to the fifth embodiment will be discussed below with reference to FIGS. 30A and 30B. The gain equalizer 31D differs from the gain equalizer 31C of the Fourth embodiment only in the structure of the dielectric multilayer filter 34.

The minus filter 35 of the gain equalizer 31D of the fifth embodiment is formed in such a way that the fifth-order reflection band (see FIG. 30B) appears at the position of the wavelength λ₀ (λ₀=1546.5 nm). The gain equalizer 31D flattens the gain spectrum in FIG. 1A using the fifth-order reflection band. In a case where the fifth-order reflection band with the wavelength λ₀—1546.6 nm is used, the designed wavelength λ_{c} is set to 7732.5 nm (1546.5 nm×5) and the optical film thickness of the first and second dielectric thin films 37 and 38 of the dielectric multilayer filter 34 is set to λ_{c}/4.

Because the minus filter 35 has the reflection band shown in FIG. 27C as in the fourth embodiment, the refractive index difference Δn between the refractive indexes of the first and second dielectric thin films 37 and 38 is set to Δn=0.04 and the lamination quantity (repeated number) m of the first and second dielectric thin films 37 and 38 is set equal to 32 (see FIG. 30A).

The gain equalizer 31D according to the fifth embodiment has the following advantage.

The minus filter 35 of the gain equalizer 31D is formed in such a way that the fifth-order reflection band appears at the position of the wavelength λ₀ corresponding to one of gain peaks (peak wavelengths) in the gain spectrum in FIG. 1A and the gain spectrum is flattened using the fifth-order reflection band. It is therefore possible to make the refractive index difference Δn greater than that of the fourth embodiment (i.e., to set Δn equal to 0.04). Further, the lamination quantity m of the dielectric thin films 37 and 38 can be made smaller than that of the fourth embodiment. Therefore, a variation in the refractive indexes of the dielectric thin films 37 and 38 can be greater than that in the fourth embodiment, thus making it easier to prepare the dielectric multilayer filter 34. As a result, the time for preparing the dielectric multilayer filter 34 can be made shorter than that in the fourth embodiment, so that the manufacturing cost is further reduced.

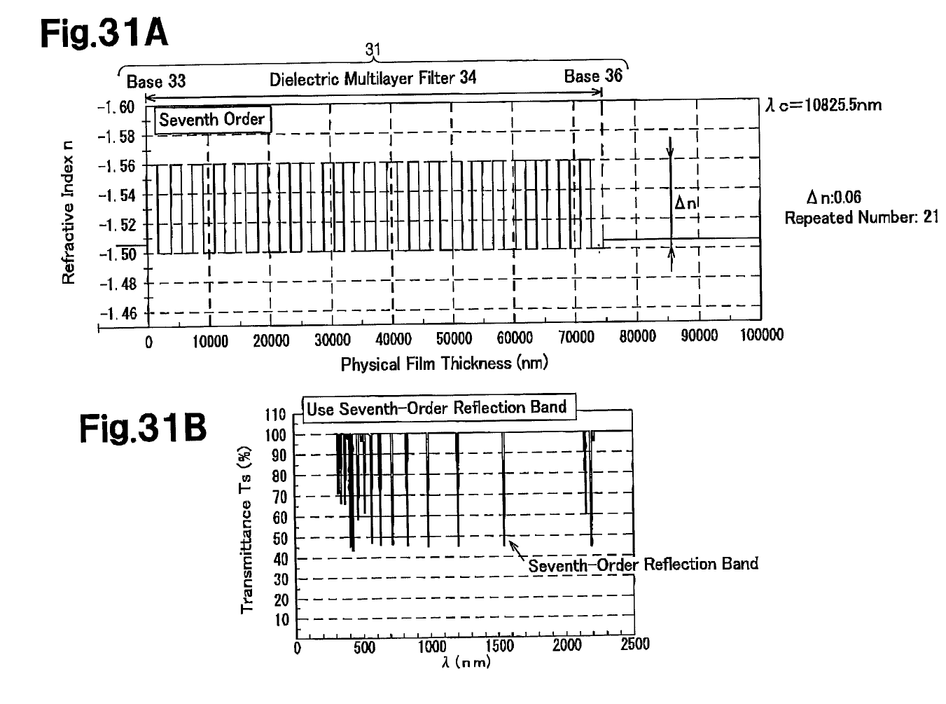

A gain equalizer 31E according to the sixth embodiment will be discussed below with reference to FIGS. 31A and 31B. The gain equalizer 31E differs from the gain equalizer 31C of the fourth embodiment only in the structure of the dielectric multilayer filter 34.

The minus filter 35 of the gain equalizer 31E of the sixth embodiment is formed in such a way that the seventh-order reflection band (see FIG. 31a) appears at the position of the wavelength λ₀ (λ₀—1546.5 nm). The gain equalizer 31E flattens the gain spectrum in FIG. 1A using the seventh-order reflection band.

In a case where the seventh-order reflection band with the wavelength λ₀=1546.5 nm is used, the designed wavelength λ_{c} is set to 10825.5 nm (1546.5 nm×7) and the optical film thickness of the first and second dielectric thin films 37 and 38 of the dielectric multilayer filter 34 is set to λ_{c}/4.

Because the minus filter 35 has the reflection band shown in FIG. 27C as in the fourth embodiment, the refractive index difference Δn between the refractive indexes of the first and second dielectric thin films 37 and 38 of the dielectric multilayer filter 34 is set to Δn=0.06 and the lamination quantity (repeated number) m of the first and second dielectric thin films 37 and 38 is set equal to 21 (see FIG. 31A).

The gain equalizer 31E according to the sixth embodiment has the following advantage.

The minus filter 35 of the gain equalizer 31E is formed in such a way that the seventh-order reflection band appears at the position of the wavelength λ₀ corresponding to one of gain peaks (peak wavelengths) in the gain spectrum in FIG. 1A and the gain spectrum is flattened using the seventh-order reflection band. It is therefore possible to make the refractive index difference Δn greater than that of the fourth embodiment (i.e., to set Δn equal to 0.06). Further, the lamination quantity m of the dielectric thin films 37 and 38 can be made smaller than that of the fifth embodiment. Therefore, a variation in the refractive indexes of the dielectric thin films 37 and 38 can be greater than that in the fifth embodiment, thus making it easier to prepare the dielectric multilayer filter 34. As a result, the time for preparing the dielectric multilayer filter 34 can be made shorter than that in the fifth embodiment, so that the manufacturing cost is further reduced.

### [COMPARATIVE EXAMPLE 5]

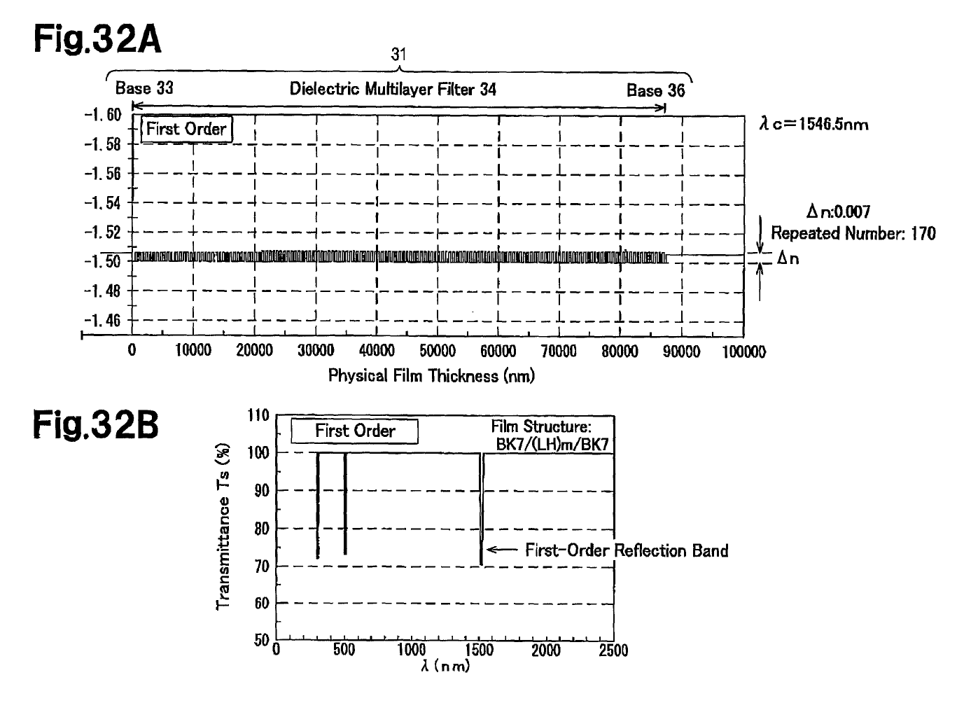

A gain equalizer according to Comparative Example 5 will be discussed below with reference to FIGS. 32A and 32B. The gain equalizer uses the first-order reflection band. The minus filter 35 is so formed as to have the reflection band shown in FIG. 27C as per the fourth embodiment.

The minus filter 35 of Comparative Example 5 is formed in such a way that the first-order reflection band (see FIG. 32B) appears at the position of the wavelength λ₀ (λ₀=1546.5 nm). In a case where the first-order reflection band with the wavelength λ₀=1546.5 nm is used, the designed wavelength λ_{c} is set to 1546.5 nm and the optical film thickness of the first and second dielectric thin films 37 and 38 of the dielectric multilayer filter 34 is set to λ_{c}/4.

The refractive index difference Δn between the refractive indexes of the dielectric thin films 37 and 38 is set to Δn=0.007 and the lamination quantity m is set equal to 170 (see FIG. 32A).

The following would be understood from the comparison with Comparative Example 5. According to the fourth to sixth embodiments, the use of a high-order reflection band can make the refractive index difference Δn significantly greater than that of Comparative Example 5 and can make the lamination quantity m significantly smaller.

It should be apparent to those skilled in the art that the present invention may be embodied in many other specific forms without departing from the spirit or scope of the invention. Particularly, it should be understood that the invention may be embodied in the following forms.

In each of the embodiments, the structure of the dielectric multilayer filter 34 may be changed to “L(HL)ₘ”, “(HL)ₘH” or “(LH)ₘ”. Here, “L(HL)ₘ” indicates the dielectric multilayer filter 34 that includes a single second dielectric thin film 38 formed on the flat surface 32 of the transparent base 33 and m sets of double-layer thin films (HL) laminated on the single second dielectric thin film 38. “(HL)ₘH” indicates the dielectric multilayer filter 34 that includes laminated m sets of double-layer thin films (HL) and a single first dielectric thin film 37 formed on the m sets of double-layer thin films (HL). “(LH)ₘ” indicates the dielectric multilayer filter 34 that includes laminated m sets of double-layer thin films (LH) and the second dielectric thin film 38 is formed on the transparent base 33 side of each double-layer thin film (LH).

In each of the embodiments, the transparent base 33 may be a lens having a flat surface which passes light, or an optical waveguide element having a flat end face. The transparent base may be a gradient index rod lens or a gradient index planar microlens or the like as shown an FIG. 8 or FIG. 9. The transparent base may also be an optical waveguide element which has a waveguide of plural channels formed in a glass substrate.

In the first embodiment, the transparent base 33 has only to pass light having a wavelength of 1550 nm. For example, the transparent base 33 may be a transparent resin substrate, a cylindrical lens having a flat surface which passes light (e.g., a gradient index rod lens) or an optic part, such as a waveguide.

In the first to third embodiments, the dielectric multilayer filter may be formed in such a way that its refractive index continuously changes in the film thickness direction. For example, the dielectric multilayer filter may be formed in such a way that the refractive index of the dielectric multilayer filter changes sinusoidally in the film thickness direction. In this case, in view of the ray optics theory, it is preferable that the amplitude of the sinusoidal function be set to Δn and the sinusoidal wavelength be set to (λ/4)×2.

In the first gain equalizer manufacturing method, niobium (Nb) or tantalum (Ta) which reacts with oxygen to become a high refractive index material, may be used as a target material.

In the first gain equalizer manufacturing method, different target materials may be adhered to the cathodes 45 and 46. The target materials in use may be titanium oxide (TiO₂; first metal oxide) of a high refractive index material and silicon oxide (SiO₂; second metal oxide) of a low refractive index material. In this case, the sputtering powers to be supplied to the cathodes 45 and 46 are adjusted and the first and second dielectric thin films 37 and 38 having desired refractive indexes are alternately laminated by non-reactive sputtering. Of non-reactive sputtering schemes, sputtering using an ion beam and sputtering using RF (high frequency) are suitable.

In the second gain equalizer manufacturing method, the sputtering power to be supplied to the cathode 45 to which Ti is attached may be changed between the time of deposition of the first dielectric thin film 37(H) and the time of deposition of the second dielectric thin film 38(L). In this case, a greater dose of titanium oxide (TiOx) of a high refractive index material is blended in the first dielectric thin film 31 which essentially consists of silicon oxide (SiOy) of a low refractive index material. A smaller dose of titanium oxide is blended in the second dielectric thin film 38 which essentially consists of silicon oxide.

In the first and second gain equalizer manufacturing methods, the dielectric multilayer filter may be formed by another physical vapor deposition (PVD) or chemical vapor deposition.

In the third gain equalizer manufacturing method, the target material is not limited to metal silicon (Si).

In the third gain equalizer manufacturing method, at the time the first and second dielectric thin films 37 and 38 are formed, the same type of reaction gas may be used but the doses of the reaction gas to be supplied to the first and second dielectric thin films 37 and 38 may be made different from each other. In this case, the first and second dielectric thin films 37 and 38 having a desired refractive index difference Δn are acquired by adequately setting the amounts of the gas supply. The refractive index difference Δn can be changed within a predetermined range by adequately setting the amounts of the gas supply.

In the fourth to sixth embodiments, the third-order, fifth-order or seventh-order reflection band may appear at a position other than the position of the wavelength λ₀−1546.5 nm.

In the fourth to sixth embodiments, a high-order (an odd-number order greater than 7) reflection band other than the third-order, fifth-order and seventh-order reflection bands may appear at the position of the wavelength λ₀=1546.5 nm.

The gain equalizers 31C, 31D and 31E according to the fourth to sixth embodiments may be adapted to a gain-equalizer equipped collimator shown in FIG. 8.

In the fourth to sixth embodiments, the refractive index difference Δn and the lamination quantity m may be altered arbitrarily in accordance with a desired high-order reflection band.

In the fourth to sixth embodiments, the dielectric multilayer filter may be formed by using the apodization scheme as done in Example 9.

In the fourth to sixth embodiments, like the gain equalizer 31B shown in FIG. 5, the gain equalizer may have plural laminated sets of minus filters (three sets in FIG. 5). In this case, the individual minus filters are formed in such a way that high-order reflection bands appear at positions corresponding to different gain peaks (peak wavelengths) in the gain spectrum of the EDFA. For example, as the loss spectra of three sets of minus filters are combined, the gain spectrum of the EDFA that has three gain peaks as shown in FIG. 1A is compensated by a simpler structure than the structure of the gain equalizer 31B.

The present examples and embodiments are to be considered as illustrative and not restrictive, and the invention is not to be limited to the details given herein, but may be modified within the scope and equivalence of the appended claims.

What is claimed is:

1. A gain equalizer for flattening a gain spectrum of an optical amplifier for amplifying a multiplexed optical signal having optical signals with a plurality of different wavelengths multiplexed, the gain spectrum having a gain peak, the gain peak having a peak wavelength, the gain equalizer comprising:
a minus filter including a transparent base having a first surface and a dielectric multilayer filter, wherein the dielectric multilayer filter has a first dielectric thin film formed on the first surface and a second dielectric thin film formed on the first dielectric thin film,
wherein both the first dielectric thin film and the second dielectric thin film have refractive indexes, and wherein the difference between the refractive index of the first dielectric thin film and the refractive index of the second dielectric thin film is relatively small so that the minus filter has a reflection characteristic for reflecting an optical signal of a predetermined wavelength band including the peak wavelength of the gain spectrum.

2. The gain equalizer according to claim 1, further comprising a transparent incidence medium adhered to the dielectric multilayer filter.

3. The gain equalizer according to claim 2, wherein the transparent base includes a second surface opposite to the first surface,
the transparent incidence medium includes an outer surface opposite to a side adhered to the dielectric multilayer filter, and the gain equalizer further comprises two antireflection films respectively formed on the second surface of the transparent base and the outer surface of the transparent incidence medium.

4. The gain equalizer according to claim 1, wherein the gain peak is one of a plurality of gain peaks, each having a peak wavelength,
the minus filter is one of a plurality of minus filters connected in series, and
each of the plurality of minus filters reflects an optical signal of a predetermined wavelength band including tho peak wavelength of one of the gain peaks.

5. The gain equalizer according to claim 4, wherein the transparent base of a minus filter in the plurality of minus filters includes a second surface opposite to the first surface, and
the gain equalizer further comprises:
a transparent incidence medium adhered to the dielectric multilayer filter and including an outer surface; and
two antireflection films respectively formed on the second surface of the transparent base and the outer surface of the transparent incidence medium.

6. The gain equalizer according to claim 1, wherein the dielectric multilayer filter includes a plurality of first dielectric thin films and a plurality of second dielectric thin films alternately laminated on the first surface of the transparent base.

7. The gain equalizer according to claim 1, wherein the difference between the refractive indexes of the first dielectric thin film and the second dielectric thin film lies within a range of 0.003 to 0.04.

8. The gain equalizer according to claim 1, wherein the refractive index of the first dielectric thin film is equal to or lower than 1.2 times the refractive index of the transparent base, and the refractive index of the second dielectric thin film is equal to or larger than 0.8 times the refractive index of the transparent base.

9. The gain equalizer according to claim 1, wherein the refractive index of the first dielectric thin film is equal to or lower than 1.1 times the refractive index of the transparent base, and the refractive index of the second dielectric thin film is equal to or larger than 0.9 times the refractive index of the transparent base.

10. The gain equalizer according to claim 2, wherein the refractive index of the transparent incidence medium is 0.8 to 1.2 times the refractive index of the transparent base.

11. The gain equalizer according to claim 2, wherein the refractive index of the transparent incidence medium is 0.9 to 1.1 times the refractive index of the transparent base.

12. A collimator connected to first and second single-mode optical fibers and having a gain equalizer for flattening a gain spectrum of an optical amplifier for amplifying a multiplexed optical signal having optical signals with a plurality of different wavelengths multiplexed, the gain spectrum having a gain peak, the gain peak having a peak wavelength, the gain equalizer comprising:
a minus filter including an incident side collimator lens for converting light output from the first single-mode optical fiber to parallel light and a dielectric multilayer filter formed on a surface of the incident side collimator lens,
a reception side collimator lens, adhered to a surface of the dielectric multilayer filter, for coupling the parallel light to the second single-mode optical fiber,
the dielectric multilayer filter including a first dielectric thin film formed on the surface of the incident side collimator lens and a second dielectric thin film formed on the first dielectric thin film,
wherein both the first dielectric thin film and the second dielectric thin film have refractive indexes, and wherein the difference between the refractive index of the first dielectric thin film and the refractive index of the second dielectric thin film is relatively small so that the dielectric multilayer filter has a reflection characteristic for reflecting an optical signal of a predetermined wavelength band including the peak wavelength of the gain spectrum.

13. The collimator according to claim 12, wherein the gain peak is one of a plurality of gain peaks, each having a peak wavelength,
the minus filter is one of a plurality of minus filters connected in series, and
each of the plurality of minus filters reflects an optical signal of a predetermined wavelength band including the peak wavelength of one of the gain peaks.

14. The collimator according to claim 12, wherein each of the incident side and reception side collimator lenses is a gradient index rod lens.

15. A method of manufacturing a gain equalizer, comprising the steps of:
preparing a transparent base;
forming a first dielectric thin film by depositing a first metal material on a surface of the transparent base by physical vapor deposition;
forming a second dielectric thin film by depositing a second metal material having a composition slightly different from a composition of the first metal material on a surface of the first dielectric thin film by physical vapor deposition; and
forming a dielectric multilayer filter by alternately depositing a plurality of first dielectric thin films and a plurality of second dielectric thin films on the surface of the transparent base.

16. A method of manufacturing a gain equalizer, comprising the steps of:
preparing a transparent base;
forming a first dielectric thin film by depositing a first metal material oil a surface of the transparent base by chemical vapor deposition;
forming a second dielectric thin film by depositing a second metal material having a composition slightly different from a composition of the first metal material on a surface of the first dielectric thin film by chemical vapor deposition; and
forming a dielectric multilayer filter by alternately depositing a plurality of first dielectric thin films and a plurality of second dielectric thin films on the surface of the transparent base.

17. A method of manufacturing a gain equalizer, comprising the steps of:
preparing a transparent base;
arranging at least one electrode on the transparent base;
forming a first dielectric thin film by supplying power to the at least one electrode to deposit at least one kind of a first metal material on a surface of the transparent base by sputtering;
forming a second dielectric thin film by supplying power to the at least one electrode to deposit at least one kind of a second metal material on a surface of the first dielectric thin film by sputtering; and
wherein the first and second dielectric thin films have refractive indexes that are different from each other.

18. The method according to claim 17, wherein the at least one electrode consists of two electrodes to which two different kinds of metal targets are attached in such a way so that the electrodes are adjacent to each other, and wherein
power to be supplied to one of the two electrodes is the same in the steps of forming the first and second dielectric thin films, and
power to be supplied to the other one of the two electrodes differs between the steps of forming the first and second dielectric thin films.

19. The method according to claim 18, wherein the two different kinds of metal targets are a first metal oxide having a high refractive index and a second metal oxide having a low refractive index, and
the steps of forming the first and second dielectric thin films deposit the first and second metal oxides on the surface of the transparent base by non-reactive sputtering.

20. The method according to claim 17, wherein the sputtering used in the steps of forming the first and second dielectric thin films uses one type of target in the presence of reaction gas, wherein the type of reaction gas in the sputtering differs between the steps of forming the first and second dielectric thin films.

21. The method according to claim 17, wherein the steps of forming the first and second dielectric thin films use one type of target and one type of reaction gas,
wherein the amount of the reaction gas in the sputtering differs between the steps of forming the first and second dielectric thin films.

22. A gain equalizer for flattening a gain spectrum of an optical amplifier for amplifying a multiplexed optical signal having optical signals with a plurality of different wavelengths multiplexed, the gain spectrum having a gain peak, the gain peak having a peak wavelength λ₀, the gain equalizer comprising:
a minus filter including a first transparent base and a dielectric multilayer filter, wherein the dielectric multilayer filter has a first dielectric thin film formed on a surface of the first transparent base and a second dielectric thin film formed on the first dielectric thin film,
wherein both the first dielectric thin film and the second dielectric thin film have refractive indexes, the refractive index of the first dielectric thin film being different from the refractive index of the second dielectric thin film, and
wherein the minus filter reflects an optical signal having the peak wavelength λ₀ of the gain spectrum at a high-order reflection band.

23. The gain equalizer according to claim 22, wherein in a case where an order of the high-order reflection band is n (n being an odd number excluding 1), the first and second dielectric thin films have an optical film thickness of nλ₀/4.

24. The gain equalizer according to claim 22, wherein the high-order reflection band is of a third order and the first and second dielectric thin films have an optical film thickness of 3λ₀/4.

25. The gain equalizer according to claim 22, wherein the high-order reflection band is of a fifth order and the first and second dielectric thin films have an optical film thickness of 5λ₀/4.

26. The gain equalizer according to claim 22, wherein the high-order reflection band is of a seventh order and the first and second dielectric thin films have an optical film thickness of 7λ₀/4.

27. The gain equalizer according to claim 22, further comprising a second transparent base formed of a same material as that of the first transparent base and adhered to the dielectric multilayer filter in such a way as to face the first transparent base.

28. The gain equalizer according to claim 22, wherein the gain peak is one of a plurality of gain peaks, each having a peak wavelength λ₀,
the minus filter is one of a plurality of minus filters connected in series, and
each of the plurality of minus filters reflects an optical signal having the peak wavelength of one of the gain peaks at a high-order reflection band.

29. The gain equalizer according to claim 28, wherein in a case where an order of each of the high-order reflection bands is n (n being an odd number excluding 1), the first and second dielectric thin films have an optical film thickness of nλ₀/4.

30. The gain equalizer according to claim 22, wherein a difference between the refractive index of the first dielectric thin film and the refractive index of the second dielectric thin film is relatively small.

31. The gain equalizer according to claim 30, wherein in a case where an order of the high-order reflection band is n (n being an odd number excluding 1), the first and second dielectric thin films have an optical film thickness of nλ₀/4.

32. The gain equalizer according to claim 22, wherein the dielectric multilayer filter includes a plurality of first dielectric thin films and a plurality of second dielectric thin films alternately laminated on the surface of the first transparent base.
